(19) United States
(12) Patent Application Publication
(10) Pub. No.: US 2025/0103982 A1
(43) Pub. Date: Mar. 27, 2025

(54) Determination of Insights for Construction Projects Based on Supply-Related Issues

(71) Applicant: Procore Technologies, Inc., Carpinteria, CA (US)

(72) Inventors: Catherine Knuff, Brooklyn, NY (US); Joshua Alexander Newland, Walnut Creek, CA (US); James Adam Pita, Middletown, MD (US)

(21) Appl. No.: 18/471,544

(22) Filed: Sep. 21, 2023

(51) Int. Cl. G06Q 10/0631; G06Q 50/08

(52) U.S. Cl. CPC G06Q 10/06313; G06Q 10/06315; G06Q 50/08

(57) ABSTRACT

A computing platform is configured to: (i) obtain a set of data objects related to construction projects, (ii) evaluate the set to identify a substitution-request-specific subset, wherein each data object of the subset corresponds to a respective substitution request, (iii) for each data object of the subset, evaluate the data object to identify one or more topics associated with the data object, (iv) based on the one or more topics, determine a supply-related issues, (v) identify a given construction project that has a likelihood of being impacted by one or more of the supply-related issues, (vi) determine one or more insights for the given construction project based on the one or more supply-related issues, and (vii) transmit, to a client station, data defining the one or more insights and thereby cause an indication of the one or more insights to be presented at a user interface of the client station.

### BACKGROUND

Construction projects are often complex endeavors involving the coordination of many professionals across several discrete phases. Typically, a construction project commences with a design phase, where architects design the overall shape and layout of a construction project, such as a building. Next, engineers engage in a planning phase where they take the architects' designs and produce engineering drawings and plans for the construction of the project. At this time, engineers may also design various portions of the project's infrastructure, such as Heating, Ventilation, and Air Conditioning (“HVAC”) systems, plumbing, electrical, etc., and produce plans reflecting these designs as well. After, or perhaps in conjunction with, the planning phase, contractors may engage in a logistics phase to review these plans and begin to allocate various resources to the project, including determining what materials to purchase, scheduling delivery, and developing a plan for carrying out the actual construction of the project. Finally, during the construction phase, construction professionals begin to construct the project based on the finalized plans.

### Overview

The fulfillment of a construction project requires the coordination of various parties involved with the construction project, and properly planning for various issues that may arise over the course of completing the construction project is important to avoid unwanted delays. In particular, it is important to ensure that construction-related items (e.g., materials, appliances, etc.) needed to continue work on the construction project are delivered in a timely manner to avoid unwanted delays in the construction project. Additionally, identifying construction-related items that may be substituted with preferable alternatives (e.g., cheaper items, items available for an earlier delivery, etc.) may help keep financial and time constraints for the construction project within a desired range.

Accordingly, it may be valuable for contractors to receive insights regarding supply-related issues that are likely to affect a given construction project. This would enable the contractors to plan around the supply-related issues, for example by (i) ordering substitute construction-related items instead of originally-planned construction-related items that are likely to experience a shortage in the near future, (ii) adjusting plans so that portions of the given construction project that are likely to impacted by a supply-related issue in the near future are performed at a time that avoids the impact(s) of the supply-related issue, and/or (iii) taking advantage of an identified preferable construction-related item purchasing opportunity by requesting a change in an original order for construction-related items.

One way to attempt to derive insights for forthcoming problems (e.g., supply-related issues) for a construction project is by evaluating historical data about prior construction projects. Historical data about prior construction projects may take various forms. In general, historical data may be any data created and stored throughout a construction project, such as data created and stored during a design phase, a planning phase, a logistics phase, and/or a construction phase of a construction project, among other possibilities. In some cases, historical data may include data objects related to the construction project that are created, stored, and accessed by users of a software as a service (“SaaS”) application for construction management. Numerous types of data objects related to construction projects are possible, examples of which include “request for information” (“RFI”) data objects (e.g., data objects for the construction project related to requested information about given project tasks), “submittal” data objects (e.g., data objects for the construction project related to information provided by a responsible contractor (such as contractors and sub-contractors) to a general contractor), “change order” data objects (e.g., data objects for the construction project related to replacement orders for construction-related items of the construction project), “conversation” data objects (e.g., data objects for communications between contractors for the particular construction project), “punch list” data objects (e.g., data objects that memorialize punch items on the construction project), and “observation” data objects (e.g., data objects for the construction project that memorialize observations made during on-site inspections of the construction project), among various other types of data objects.

However, attempting to derive insights for forthcoming problems (e.g., supply-related issues) that may be likely to occur on a construction project from historical data such as this can present numerous problems. For example, historical data may take the form of various different types of data objects (which may comprise a mix of structured and unstructured data) and the historical data may not be well organized. Such a mix of data and such organization may make it difficult to evaluate the historical data and derive insights for forthcoming problems for a construction project. Further, the data may be voluminous, which may also make it difficult to evaluate and derive insights from the historical data. In this regard, not only may there be a large number of completed or ongoing construction projects to be evaluated, but there may also be, for any given construction project, a large number of historical data objects representing construction-project-related action items (which may be on the order of thousands, tens of thousands, hundreds of thousands, millions, etc.). These factors (among others) make it difficult to extract meaningful insights for forthcoming problems for a construction project from such historical data.

To help address the aforementioned and other problems, disclosed herein is new software technology for determining one or more insights related to a construction project based on data indicative of one or more supply-related issues. In practice, the disclosed software technology could be implemented in a SaaS application for construction management, such as the SaaS application offered by Procore Technologies, Inc., but it should be understood that the disclosed technology for determining insights for construction projects based on supply-related issues may be incorporated into various other types of software applications as well (including software applications in industries other than construction).

A software application such as a SaaS application for construction management may have access to data associated with substitution requests for construction projects which may be used to facilitate determination of supply-related issues, as well as other construction-relevant data (e.g., external construction-relevant data) which may also be used to facilitate determination of supply-related issues. Data associated with substitution requests for construction projects may, for example, reside in (i) submittals and (ii) requests for information (RFIs), both of which are regularly utilized by workers of construction projects. Substitution requests and the data contained therein may be indicative of one or more supply-related issues. Further, construction-relevant data may originate and/or be obtained from various sources, such as news organizations, government agencies, construction-related organizations, and the like, which may include information indicative of one or more supply-related issue.

The software technology disclosed herein may provide various benefits over existing techniques for deriving insights for forthcoming problems (e.g., supply-related issues) from historical data. For instance, the software technology disclosed enables a back-end computing platform to determine one or more supply-related issues based on data objects that correspond to respective substitution requests, which may provide a meaningful resource for determining supply-related issues. Further, the software technology disclosed enables a back-end computing platform to determine one or more supply-related issues based on construction-relevant data, which may provide a meaningful resource for determining supply-related issues based on circumstances that are likely to impact the fulfillment of construction projects.

In accordance with the above, in one aspect, disclosed herein is a method that involves a computing platform: (i) obtaining a set of data objects related to construction projects; (ii) evaluating the obtained set of data objects and thereby identifying a substitution-request-specific subset of the obtained set of data objects, wherein each data object of the substitution-request-specific subset corresponds to a respective substitution request of a plurality of substitution requests; (iii) for each data object of the substitution-request-specific subset, evaluating the data object and thereby identify one or more topics associated with the data object; (iv) based at least on the identified one or more topics associated with the data objects of the substitution-request-specific subset, determining a plurality of supply-related issues; (v) identifying a given construction project that has a likelihood of being impacted by one or more of the plurality of supply-related issues; (vi) determining one or more insights for the given construction project based on the one or more of the plurality of supply-related issues; and (vii) transmitting, to a client station, data defining the one or more insights for the given construction project and thereby causing an indication of the one or more insights to be presented at a user interface of the client station.

In another aspect, disclosed herein is a computing system that includes at least one processor, at least one non-transitory computer-readable medium, and program instructions stored on the at least one non-transitory computer-readable medium that are executable by the at least one processor to cause the computing platform to carry out the functions disclosed herein, including but not limited to the functions of the foregoing method.

In yet another aspect, disclosed herein is a non-transitory computer-readable medium comprising program instructions that are executable to cause a computing platform to carry out the functions disclosed herein, including but not limited to the functions of the foregoing method.

In still yet another aspect, disclosed herein is a method that involves a computing platform: (i) obtaining a set of construction-relevant data; (ii) evaluating the obtained set of construction-relevant data and thereby identify a construction-project-fulfillment-relevant subset of data items of the obtained set of construction-relevant data, wherein each data item of the construction-project-fulfillment-relevant subset corresponds to construction project fulfillment; (iii) evaluating the data items of the construction-project-fulfillment-relevant subset and thereby determine a plurality of supply-related issues; (iv) identifying a given construction project that has a likelihood of being impacted by one or more of the plurality of supply-related issues; (v) determining one or more insights for the given construction project based on the one or more supply-related issues; and (vi) transmitting, to a client station, data defining the one or more insights for the given construction project and thereby cause an indication of the one or more insights to be presented at a user interface of the client station.

In still yet another aspect, disclosed herein is a computing system that includes at least one processor, at least one non-transitory computer-readable medium, and program instructions stored on the at least one non-transitory computer-readable medium that are executable by the at least one processor to cause the computing platform to carry out the functions disclosed herein, including but not limited to the functions of the foregoing method.

In still yet another aspect, disclosed herein is a non-transitory computer-readable medium comprising program instructions that are executable to cause a computing platform to carry out the functions disclosed herein, including but not limited to the functions of the foregoing method.

One of ordinary skill in the art will appreciate these as well as numerous other aspects in reading the following disclosure.

### BRIEF DESCRIPTION OF THE DRAWINGS

FIG. 1 depicts an example network configuration in which example embodiments may be implemented.

FIG. 2 depicts an example computing platform that may be configured to carry out one or more of the functions according to the disclosed technology.

FIG. 3 depicts an example process for facilitating the determination of one or more insights related to a construction project based on substitution requests, according to the disclosed technology.

FIG. 4 depicts a conceptual illustration of an example data science model for predicting whether a data object corresponds to a substitution request, according to the disclosed technology.

FIG. 5 depicts a conceptual illustration of an example data science model for predicting the one or more topics to which a given data object corresponds, according to the disclosed technology.

FIG. 6 depicts an example snapshot of a graphical user interface (GUI) that displays information regarding one or more insights, according to the disclosed technology.

FIG. 7 depicts an example process for facilitating the determination of one or more insights related to a construction project based on construction-relevant data, according to the disclosed technology.

FIG. 8 depicts a conceptual illustration of one example of a data science model for determining whether a data item of construction-relevant data corresponds to construction project fulfillment, according to the disclosed technology.

FIG. 9 depicts a conceptual illustration of one example of a data science model for determining whether a data item of construction-relevant data corresponds to one or more topics and/or circumstances, according to the disclosed technology.

FIG. 10 depicts an example snapshot of a GUI that displays information regarding one or more insights, according to the disclosed technology.

### DETAILED DESCRIPTION

The following disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners, each of which is contemplated herein.

As noted above, the present disclosure generally relates to technology for determining one or more insights related to a construction project based on data indicative of one or more supply-related issues. In practice, the disclosed technology may be incorporated into a software as a service (“SaaS”) application for managing construction projects, which may include back-end software that runs on a back-end computing platform and front-end software that runs on users' client stations (e.g., in the form of a native application, a web application, and/or a hybrid application, etc.) and can be used to access the SaaS application via a data network, such as the Internet. For example, as one possible example, the disclosed technology may be incorporated into a SaaS application for construction management, such as the one offered by Procore Technologies, Inc. However, other examples are possible as well.

### I. Example System Configuration

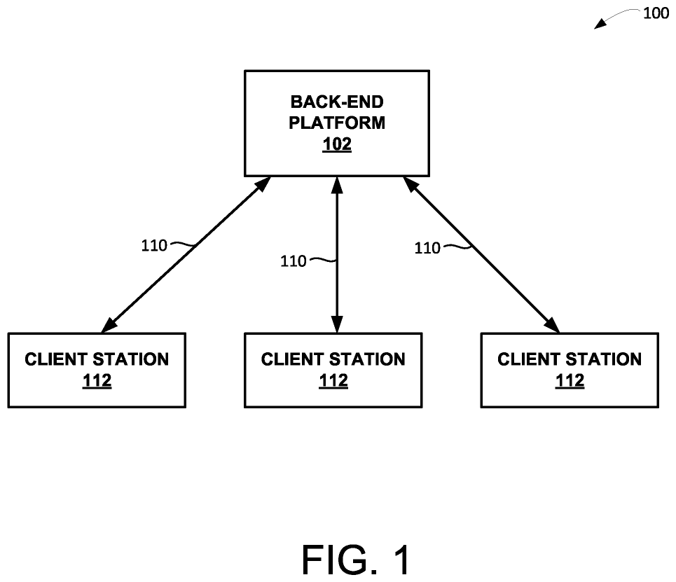

Turning now to the figures, FIG. 1 depicts an example network configuration 100 in which example embodiments of the present disclosure may be implemented. As shown in FIG. 1, network configuration 100 includes a back-end computing platform 102 that may be communicatively coupled to one or more client stations, depicted here, for the sake of discussion, as client stations 112.

Broadly speaking, the back-end computing platform 102 may comprise one or more computing systems that have been installed with back-end software (e.g., program code) for hosting an example SaaS application that incorporates the disclosed technology and delivering it to users over a data network. The one or more computing systems of the back-end computing platform 102 may take various forms and be arranged in various manners.

For instance, as one possibility, the back-end computing platform 102 may comprise cloud computing resources that are supplied by a third-party provider of “on demand” cloud computing resources, such as Amazon Web Services (AWS), Amazon Lambda, Google Cloud Platform (GCP), Microsoft Azure, or the like, which may be provisioned with software for carrying out one or more of the functions disclosed herein. As another possibility, the back-end computing platform 102 may comprise “on-premises” computing resources of the organization that operates the back-end computing platform 102 (e.g., organization-owned servers), which may be provisioned with software for carrying out one or more of the functions disclosed herein. As yet another possibility, the back-end computing platform 102 may comprise a combination of cloud computing resources and on-premises computing resources. Other implementations of the back-end computing platform 102 are possible as well.

In turn, the client stations 112 may each be any computing device that is capable of accessing the SaaS application hosted by the back-end computing platform 102. In this respect, the client stations 112 may each include hardware components such as a processor, data storage, a communication interface, and user-interface components (or interfaces for connecting thereto), among other possible hardware components, as well as software components that facilitate the client station's ability to access the SaaS application hosted by the back-end computing platform 102 and run the front-end software of the SaaS application (e.g., operating system software, web browser software, mobile applications, etc.). As representative examples, the client stations 112 may each take the form of a desktop computer, a laptop, a netbook, a tablet, a smartphone, and/or a personal digital assistant (PDA), among other possibilities.

As further depicted in FIG. 1, the back-end computing platform 102 may be configured to interact with the client stations 112 over respective communication paths 110. In this respect, each communication path 110 between the back-end computing platform 102 and one of the client stations 112 may generally comprise one or more communication networks and/or communications links, which may take any of various forms. For instance, each respective communication path 110 with the back-end computing platform 102 may include any one or more of point-to-point links, Personal Area Networks (PANs), Local-Area Networks (LANs), Wide-Area Networks (WANs) such as the Internet or cellular networks, and/or cloud networks, among other possibilities. Further, the communication networks and/or links that make up each respective communication path 110 with the back-end computing platform 102 may be wireless, wired, or some combination thereof, and may carry data according to any of various different communication protocols. Although not shown, the respective communication paths 110 between the client stations 112 and the back-end computing platform 102 may also include one or more intermediate systems. For example, it is possible that the back-end computing platform 102 may communicate with a given client station 112 via one or more intermediary systems, such as a host server (not shown). Many other configurations are also possible.

While FIG. 1 shows an arrangement in which three client stations are communicatively coupled to the back-end computing platform 102, it should be understood that this is merely for purposes of illustration and that any number of client stations may communicate with the back-end computing platform 102.

Although not shown in FIG. 1, the back-end computing platform 102 may also be configured to interact with other third-party computing platforms, such as third-party computing platforms operated by organizations that have subscribed to the SaaS application and/or third-party computing platforms operated by organizations that provide the back-end computing platform 102 with third-party data for use in the SaaS application. Such computing platforms, and the interaction between the back-end computing platform 102 and such computing platforms, may take various forms.

It should be understood that network configuration 100 is one example of a network configuration in which embodiments described herein may be implemented. Numerous other arrangements are possible and contemplated herein. For instance, other network configurations may include additional components not pictured and/or more or fewer of the pictured components.

### II. Example Computing Platform

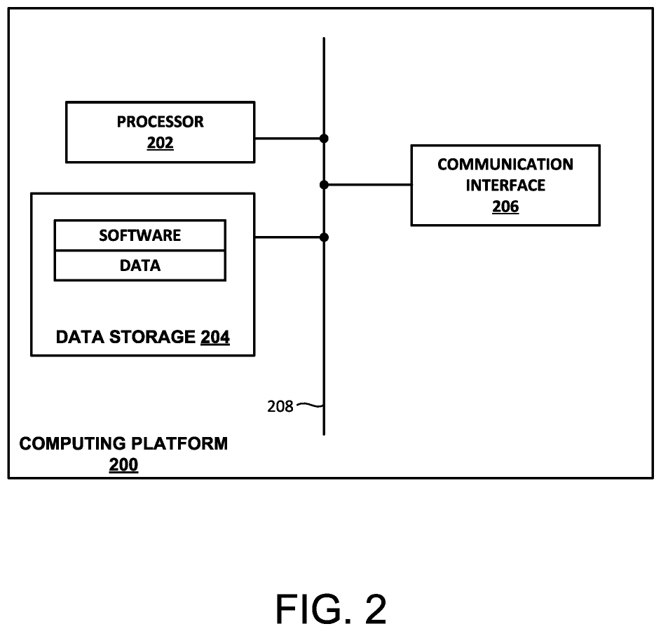

FIG. 2 is a simplified block diagram illustrating some structural components that may be included in an example computing platform 200, which could serve as, for instance, the back-end computing platform 102 of FIG. 1. In line with the discussion above, the computing platform 200 may generally comprise one or more computer systems (e.g., one or more servers), and these one or more computer systems may collectively include at least a processor 202, data storage 204, and a communication interface 206, all of which may be communicatively linked by a communication link 208 that may take the form of a system bus, a communication network such as a public, private, or hybrid cloud, or some other connection mechanism.

The processor 202 may comprise one or more processing components, such as general-purpose processors (e.g., a single- or multi-core microprocessor), special-purpose processors (e.g., an application-specific integrated circuit or digital-signal processor), programmable logic devices (e.g., a field programmable gate array), controllers (e.g., microcontrollers), and/or any other processor components now known or later developed. In line with the discussion above, it should also be understood that the processor 202 could comprise processing components that are distributed across a plurality of physical computing devices connected via a network, such as a computing cluster of a public, private, or hybrid cloud.

In turn, the data storage 204 may comprise one or more non-transitory computer-readable storage mediums that are collectively configured to store (i) program instructions that are executable by the processor 202 such that the computing platform 200 is configured to perform some or all of the disclosed functions, which may be arranged together into engineering artifacts or the like, and (ii) data that may be received, derived, or otherwise stored by the computing platform 200 in connection with the disclosed functions. In this respect, the one or more non-transitory computer-readable storage mediums of the data storage 204 may take various forms, examples of which may include volatile storage mediums such as random-access memory, registers, cache, etc. and non-volatile storage mediums such as read-only memory, hard-disk drives, solid-state drives, flash memory, optical-storage devices, etc. Further, the data storage 204 may utilize any of various types of data storage technologies to store data within the computing platform 200, examples of which may include relational databases, NoSQL databases (e.g., columnar databases, document databases, key-value databases, graph databases, etc.), file-based data stores (e.g., Hadoop Distributed File System or Amazon Elastic File System), object-based data stores (e.g., Amazon S3), data warehouses (which could be based on one or more of the foregoing types of data stores), data lakes (which could be based on one or more of the foregoing types of data stores), message queues, and/or streaming event queues, among other possibilities. Further yet, in line with the discussion above, it should also be understood that the data storage 204 may comprise computer-readable storage mediums that are distributed across a plurality of physical computing devices connected via a network, such as a storage cluster of a public, private, or hybrid cloud. Data storage 204 may take other forms and/or store data in other manners as well.

The communication interface 206 may be configured to facilitate wireless and/or wired communication with client stations (e.g., one or more client stations 112 of FIG. 1) and/or third-party computing platform. Additionally, in an implementation where the computing platform 200 comprises a plurality of physical computing systems connected via a network, the communication interface 206 may be configured to facilitate wireless and/or wired communication between these physical computing systems (e.g., between computing and storage clusters in a cloud network). As such, the communication interface 206 may take any suitable form for carrying out these functions, examples of which may include an Ethernet interface, a serial bus interface (e.g., Firewire, USB 2.0, etc.), a chipset and antenna adapted to facilitate any of various types of wireless communication (e.g., WiFi communication, cellular communication, etc.), and/or any other interface that provides for wireless and/or wired communication. The communication interface 206 may also include multiple communication interfaces of different types. Other configurations are possible as well.

Although not shown, the computing platform 200 may additionally include or have an interface for connecting to user-interface components that facilitate user interaction with computing platform 200, such as a keyboard, a mouse, a trackpad, a display screen, a touch-sensitive interface, a stylus, a virtual-reality headset, and/or speakers, among other possibilities.

It should be understood that the computing platform 200 is one example of a computing system that may be used with the embodiments described herein. Numerous other arrangements are possible and contemplated herein. For instance, other computing systems may include additional components not pictured and/or more or fewer of the pictured components.

### III. Example Operations

As mentioned above, the present disclosure generally relates to technology for the determination of insights related to construction projects based on supply-related issues that may be identified by a back-end computing platform, such as the back-end computing platform 102 of FIG. 1. The back-end computing platform 102 may host a SaaS application comprising front-end software running on users' client stations and back-end software running on the back-end computing platform that is accessible to the client stations via a data network, such as the Internet. For instance, the disclosed technology is described below in the context of a SaaS application for construction management, such as the SaaS application offered by Procore Technologies, Inc., but it should be understood that the disclosed technology may be utilized to determine insights related to construction projects based on supply-related issues in various other contexts as well.

### A. Construction Project Data

In accordance with the disclosed technology, the back-end computing platform 102 may be configured to facilitate management of a plurality of construction projects. In this regard, the back-end computing platform 102 may create and store “construction project” data objects (or “project” data objects for short) that each represents a construction project workspace for a particular construction project in the real world. Each “project” data object may in turn be used to organize various types of other data objects related to the particular construction project. Data objects related to the particular construction project and associated with the “project” data object may generally comprise data that provides information about the particular construction project. Further, such data objects could take any of various different forms depending on the nature of the SaaS application.

For instance, a SaaS application for construction management may allow various different types of data objects related to the particular construction project to be created, stored, and accessed by users of the SaaS application. In practice, there may be various types of data objects related to the particular construction project, examples of which include “request for information” (“RFI”) data objects (e.g., data objects for the construction project related to requested information about given project tasks), “submittal” data objects (e.g., data objects for the construction project related to information provided by a responsible contractor (such as contractors and sub-contractors) to a general contractor), “change order” data objects (e.g., data objects for the construction project related to replacement orders for construction-related items of the construction project), and “conversation” data objects (e.g., data objects for communications between contractors for the particular construction project), among various other types of data objects.

Within the SaaS application, each data-object type may represent data items of different types and thus data objects of different data-object types may be comprised of different sets of data fields compared to data objects of other data-object types. As an illustrative example, an “RFI” data object may include a different set of data fields than a “submittal” data object. For instance, an “RFI” data object may include data fields of “RFI number,” “Subject,” “Status,” “Created By,” “Date Initiated,” “RFI Manager,” “Distribution List,” “Assignees,” “Due Date,” “Received From,” “Responsible Party,” “Drawing Number(s),” “Linked Drawing(s),” “Specification Section,” “Location,” “Schedule Impact,” “Cost Code,” “Cost Impact,” “Reference,” “Ball in Court,” “Question(s),” and/or “Response(s),” among other possibilities.

On the other hand, a “submittal” data object may include data fields of various groupings including, for instance, “General Information” data fields, “Submittal Schedule Information” data fields, and “Delivery Information” data fields. In an example, “General Information” data fields may include “Specification section,” “Responsible Contractor,” “Submit By,” “Cost Code,” “Ball in Court,” “Submittal Number & Revision,” “Received From,” “Received Date,” “Location,” “Submittal Type,” “Submittal Manager,” “Issue Date,” “Linked Drawings,” “Submittal Package,” “Status,” “Final Due Date,” “Distribution List,” and “Description,” among other possibilities. Further, in an example, “Submittal Schedule Information” data fields may include “Schedule Task,” “Required On-Site Date,” “Lead Time,” “Design Team Review Time,” “Internal Review Time,” “Planned Return Date,” “Planned Internal Review Completed Date,” and “Planned Submit By Date,” among other possibilities. Still further, in an example, “Delivery Information” data fields may include “Anticipated Delivery Date,” “Confirmed Delivery Date,” and “Actual Delivery Date,” among other possibilities. Other data-object types may have different sets of data fields, as well as possibly one or more similar data fields.

Further, in at least some examples, the SaaS application for construction management may provide various software features (also referred to as tools) that allow for creation and interaction with different types of data objects. For instance, such tools may include an “RFI” tool where a user may enter RFI data items for the construction project to request and/or provide information about given project tasks, a “submittals” tool where a user may enter submittal data items, and a “conversations” tool where a user may send and receive conversational messages regarding the construction project. Other tools are possible as well. Further, in some examples, a given tool may allow a user to create, store, access, and/or modify a plurality of different types of data objects.

The stored data objects associated with the “project” data objects may be used by the back-end computing platform 102 to drive various functionality for deriving insights from supply-related issues identified by the back-end computing platform 102, as described in further detail below.

B. Supply-Related Issues Associated with Construction Projects

As may be appreciated, completing a construction project may involve the use of numerous construction-related items. Various types of construction-related items are possible including, for instance, raw materials (e.g., steel, wood, etc.), industry-specific products (e.g., wires, concrete, etc.), end-user appliances (e.g., refrigerators, air handlers for HVAC units, etc.), equipment and tools used by contractors to complete construction projects (e.g., excavators, rollers, etc.), among various other types of construction-related items. As part of the planning process for a construction project, contractors may order construction-related items to be used in the fulfillment of the construction project. However, throughout a construction project, there may be, for one reason or another, instances where substitution requests are made to change original orders for construction-related items. For instance, in an example, substitution requests may be made to request that substitute construction-related items be ordered instead of originally-planned construction-related items. Additionally or alternatively, substitution requests may be made to request that construction-related items be ordered from a substitute provider of the construction-related item instead of from an originally-planned provider of the construction-related item. Various other types of requests to change orders for construction-related items are possible as well.

The reasons for such substitution requests may generally stem from one or more supply-related issues. One example supply-related issue may be a supply-chain issue for a given construction-related item, which may take any of various forms. One possible type of supply-chain issue may be a provider-specific shortage or impending shortage of the given construction-related item. Another possible type of supply-chain issue may be a wide-spread shortage or impending shortage of the given construction-related item for a plurality of providers of the given construction-related item. Yet another possible type of supply-chain issue may be a delivery timeline for a given construction-related item that is greater than desired. In some cases, there may be an availability of a substitute construction-related item purchasing opportunity to purchase a given construction-related item from a different provider of the construction-related item than the originally-planned construction-related item, for example, for a more ideal delivery timeline). In other cases, there may be an availability of a substitute construction-related item purchasing opportunity to purchase a given construction-related item from the originally-planned provider of the given construction-related item, for example, for a more ideal delivery timeline. As discussed in greater detail below, various information that may be identified from substitution requests referencing the given construction-related item may be indicative of a supply-chain issue for the given construction-related item and/or a type of supply-chain issue for the given construction-related item.

Another example supply-related issue may be a cost-related issue for a given construction-related item. Various types of cost-related issues for a given construction-related item are possible. One possible type of cost-related issue for a given construction-related item may be an availability of a purchasing opportunity to purchase the given construction-related item from a different provider of the construction-related item than from the originally-planned provider, for example, for a reduced price. Another type of cost-related issue for a given construction-related item may be an availability of a substitute construction-related item purchasing opportunity, for example, for a reduced price. The substitute construction-related item purchasing opportunity may be from the originally-planned provider of the originally-planned construction-related item and/or from a different provider. As discussed in greater detail below, various information that may be identified from substitution requests referencing the given construction-related item may be indicative of a cost-related issue for the given construction-related item and/or a type of cost-related issue for the given construction-related item.

Yet another example supply-related issue may be a quality-related issue for a given construction-related item where an opportunity to purchase a different (e.g., higher) quality construction-related item may exist. As used herein, the quality of a given construction-related item may refer to or be measured against performance standards. In an example, a first construction-related item may be of a higher-quality than another construction-related item if the first construction-related item exceeds performance standards of the second construction-related item, although various other measures of quality may also be used. One possible type of quality-related issue may be an availability of a substitute construction-related item purchasing opportunity to purchase a substitute construction-related item, wherein the substitute construction-related item is of a higher quality than an originally-planned construction-related item. The substitute construction-related item purchasing opportunity may be from the originally-planned provider of the originally-planned construction-related item and/or from a different provider. As discussed in greater detail below, various information that may be identified from substitution requests that reference the given construction-related item may be indicative of a quality-related issue for the given construction-related item and/or a type of quality issue for the given construction-related item.

Various other supply-related issues are possible as well.

As may be appreciated, it may be desirable to gain insight into supply-related issues that may occur during a construction project in time for preventative and/or advantageous action to be taken. For example, if a contractor was made aware that a given construction-related item originally planned to be ordered for the construction project is experiencing a shortage or is likely to experience a shortage that would impact the given construction-related item's scheduled delivery or cost, the contractor may take action to avoid the supply-related issue for the given construction-related item (e.g., submit a substitution request to have a substitute construction-related item delivered for the construction project instead of the given construction-related item).

As another example, if a contractor (i) had originally planned to order a given construction-related item from a first provider of the given construction-related item and (ii) was made aware that a second provider of the given construction-related item can (a) deliver the given construction-related item sooner than the first provider can and/or (b) offer the construction-related item for a lower price than the first provider can, then the contractor may submit a substitution request to order the given construction-related item from the second provider, instead of the first construction-related item. Various other examples of preventative and/or advantageous actions are also possible.

Certain data objects related to construction projects may correspond to these supply-related issues. For instance, some “RFI” data objects may correspond to supply-related issues. As another example, some “submittal” data objects may correspond to supply-related issues. Various other data objects may also correspond to supply-related issues. Further, given data objects may correspond to different supply-related issues. As an illustrative example, a first data object (e.g., an “RFI” data object) may be related to a supply-chain issue for a given construction-related item, a second data object (e.g., a “submittal” data object) may be related to a preferable construction-related item purchasing opportunity over an originally-planned construction-related item purchasing order, and a third data object (e.g., a “change order” data object) may be related to another supply-chain issue for a different construction-related item. Other examples of data objects corresponding to supply-related issues are possible as well.

Various analyses may be performed with respect to data objects related to construction projects to identify data objects and/or various aspects of data objects that may be indicative of one or more of the supply-related issues. For example, an analysis may be performed to identify, from a pool of data objects, data objects that correspond to respective substitution requests, as well as an analysis to identify topic information for one or more topics associated with the identified data objects, from which one or more supply-related issues may be identified. These analyses are described in greater detail below.

C. Determining Insights for Construction Projects Based on Supply-Related Issues Identified from Data Objects Related to Construction Projects

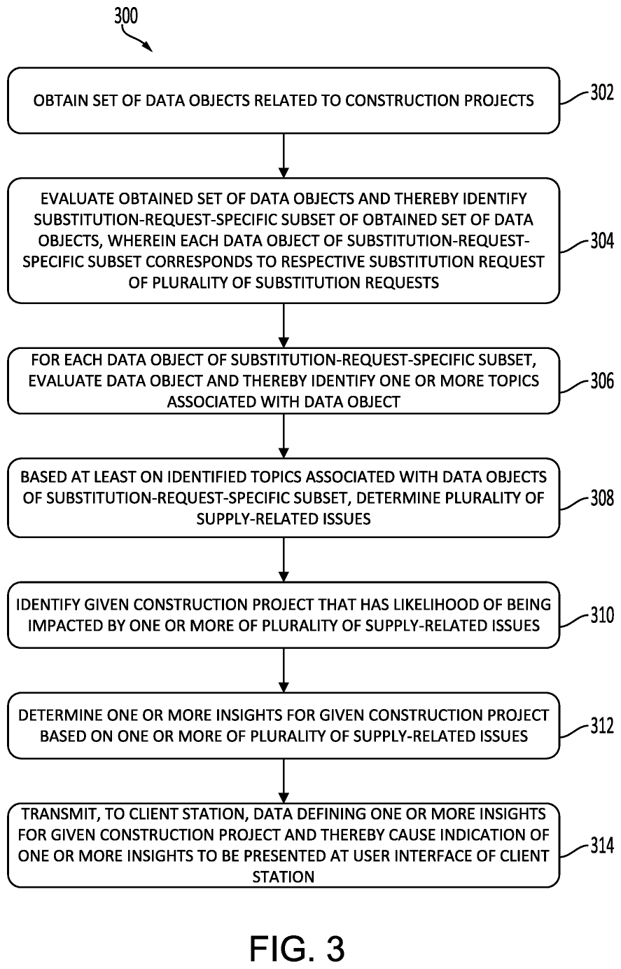

Turning now to FIG. 3, a flowchart 300 is shown, which illustrates one example of a process that may be carried out in accordance with the disclosed technology to facilitate the determination of one or more insights related to a new or ongoing construction project based on substitution requests that have been submitted for prior (e.g., completed or ongoing) construction projects. For purposes of illustration only, the flowchart 300 is described as being carried out by the back-end computing platform 102 of FIG. 1, but it should be understood that the flowchart 300 may be carried out by computing platforms that take other forms as well. Further, it should be understood that, in practice, the functions described with reference to FIG. 3 may be encoded in the form of program instructions that are executable by one or more processors of the back-end computing platform 102. Further yet, it should be understood that the disclosed process is merely described in this manner for the sake of clarity and explanation and that the example embodiment may be implemented in various other manners, including the possibility that functions may be added, removed, rearranged into different orders, combined into fewer blocks, and/or separated into additional blocks depending upon the particular embodiment.

### 1. Obtain Set of Data Objects

Beginning at block 302, the back-end computing platform 102 may obtain a set of data objects related to construction projects, which for example may be obtained from a pool of construction projects (e.g., a pool of prior or ongoing construction projects). As described above, the back-end computing platform 102 may store a plurality of data objects for each of the construction projects of the SaaS application. The back-end computing platform 102 may obtain the set of data objects related to the construction projects in various ways, such as by accessing the data objects from the data storage 204, among various other possibilities.

In general, the obtained set of data objects may be any appropriate set of data objects from which substitution requests for construction projects may be determined. As one possibility, the set of data objects may include all or a portion of the data objects from each respective type of data object in a set of types of data objects. For instance, in an example, the set of types of data objects may include “RFI” data objects, “submittal” data objects, “change order” data objects, and “conversation” data objects, and the set of obtained data objects may include all or a portion of the data objects from each of those types.

### 2. Identification of Substitution-Request-Specific Data Objects

At block 304, the back-end computing platform 102 may evaluate the obtained set of data objects and thereby identify a substitution-request-specific subset of the obtained set of data objects, where each data object of the substitution-request-specific subset corresponds to a respective substitution request of a plurality of substitution requests. The back-end computing platform 102 may perform the operations of block 304 in various ways. In at least some implementations, the back-end computing platform 102 may utilize one or more data analytics operations that serve to analyze data objects of the set of data objects across the different types of data objects and/or tools in order to determine which of the data objects of the set of data objects correspond to a substitution request. Such a data analytics operation may be performed on an object-by-object basis and may take various forms.

As one possibility, the data analytics carried out by the back-end computing platform 102 to determine which of the obtained data objects correspond to a substitution request may be embodied in the form of one or more data science models that are each configured to determine, on an object-by-object basis, whether a given data object corresponds to a substitution request. In an example, such a data science model may take the form of one or more machine learning models created using various machine learning techniques, one example machine learning model being a classification model.

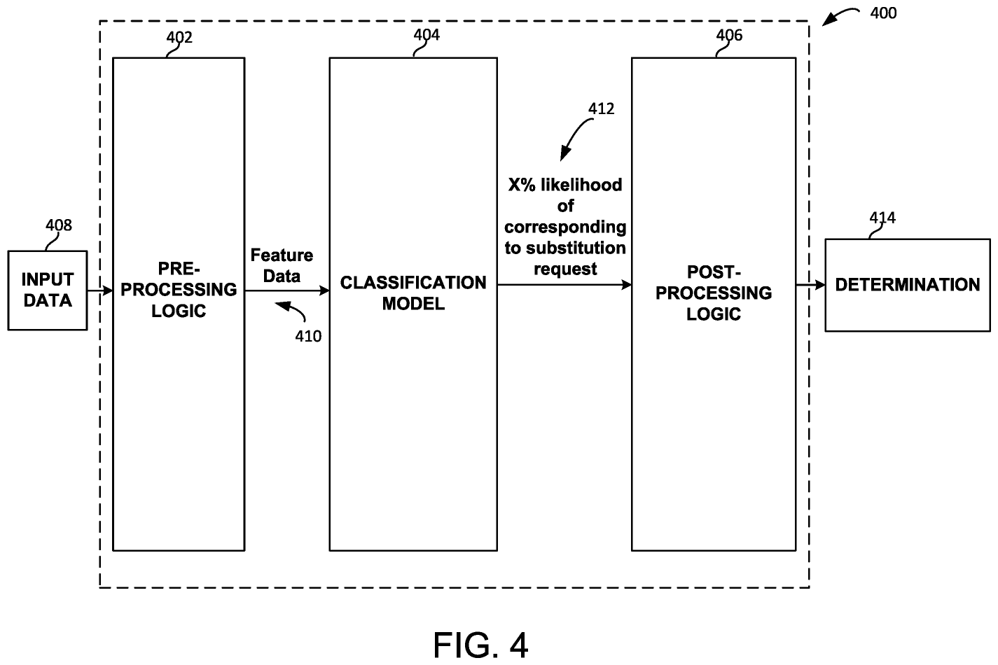

In this regard, FIG. 4 depicts a conceptual illustration of an example of a data science model 400 for predicting which data objects correspond to a substitution request that comprises pre-processing logic 402, a classification model 404, and post-processing logic 406. At a high level, the pre-processing logic 402 may function to (i) receive input data 408 for a given data object of the obtained set of data objects and (ii) transform the input data 408 for the given data object into feature data 410 for the given data object, which is then provided as input to the classification model 404. In turn, the classification model 404 may be configured to (i) receive the feature data 410 for the given data object as input, (ii) evaluate the feature data 410 for the given data object, and (iii) based on the evaluation of the feature data 410, determine and output a prediction 412 that takes the form of predicted likelihood that the given data object corresponds to a substitution request. In turn, the post-processing logic 406 (e.g., a likelihood-percentage threshold) may function to evaluate the prediction 412 and then determine whether the given data object corresponds to a substitution request. These aspects of the data science model 400 will now be described in greater detail.

The input data 408 for the given data object that is input into the data science model 400 may generally comprise any data that may be utilized to produce the feature data 410 for the given data object and may take any of various forms. In an example, the input data 408 may include all the data values associated with the given data object. In another example, the input data 408 may include a subset of the data values associated with the given data object. For instance, in practice, certain data values associated with the given data object (e.g., data values in certain data fields) may have more influence or weight (compared to other data values) with respect to determining whether the given data object corresponds to a substitution request, in which case the classification model 404 may be configured to receive and evaluate only a subset of the data values for the given data object. As an illustrative example using an “RFI” data object having the data fields discussed above, rather than the input data 408 including all of the data values for each data field of an “RFI” data object, the input data 408 may include a subset of the data values for the “RFI” data object, such as the data values for the data fields of “Question(s)” and “Response(s).” Other examples are possible as well.

As noted above, the input data 408 for the given data object may be received by the pre-processing logic 402 of the data science model 400, which may function to transform the input data 408 into the feature data 410 for the given data object, which is then input into the classification model 404. In this respect, the feature data 410 for the given data object may generally comprise data for any feature variables that may facilitate a prediction of whether the given data object corresponds to a substitution request. This feature data 410—and the pre-processing logic 402 that produces the feature data 410—may take any of various forms.

As one possibility, the pre-processing logic 402 may take the form of Natural Language Processing (“NLP”) logic that performs NLP techniques to analyze data values associated with the data object and translate those data values into the feature data 410. Such NLP techniques may include, as some nonlimiting examples, identifying and extracting keywords and/or key features from the raw text included in user-input data, correcting any spelling and/or grammatical errors, unification, non-ascii character removal, stop word removal, lemmatization, and sentiment analysis. As an illustrative example, using an “RFI” data object having the data fields discussed above, the back-end computing platform 102 may pre-process data values associated with the “Question(s)” and “Response(s)” data fields, so as to translate those data values into the feature data 410. For instance, the pre-processing may involve looking for phrases such as “substitute,” “replacement,” “availability,” and/or “cheaper” in the “Question(s)” and/or “Response(s)” data fields, as such language may be indicative of a substitution request. The pre-processing logic 402 may also look for various other phrases as well. Further, this matching may include a fuzziness component that looks for synonyms or near-match phrases. As another illustrative example, using a “submittal” data object having the data fields discussed above, the back-end computing platform 102 may pre-process data values associated with the “Description” data fields, so as to translate those data values into the feature data 410.

As another possibility, there may be one or more additional machine learning models as part of the pre-processing logic 402. For instance, the pre-processing logic 402 may use a pre-trained topic model, such as a Bidirectional Encoder Representations from Transformers (BERT) topic model (e.g., BERTopic model), to extract out topics that may then be used as the feature data 410 by the classification model 404. The pre-processing logic 402 may take various other forms as well.

In line with the discussion above, the classification model 404 is configured to receive the feature data 410 for the given data object, evaluate the feature data 410, and then based on the evaluation, output the prediction 412 that takes the form of predicted likelihood that the given data object corresponds to a respective substitution request. For instance, as shown in FIG. 4, the classification model 404 may output the prediction 412, which is shown in FIG. 4 as X %. However, the predictions output by the classification model 404 may take other forms as well.

In turn, the post-processing logic 406 of the data science model 400 may function to evaluate the predictions 412 output by the classification model 404 in order to reach a determination 414 as to whether the given data object corresponds to a substitution request. This post-processing logic 406 may take various forms.

As one possibility, the post-processing logic 406 may function to (i) determine that the given data object corresponds to a substitution request if the predicted likelihood satisfies a threshold value, or (ii) determine that the given data object does not correspond to a substitution request if the predicted likelihood does not satisfy the threshold value. With reference to FIG. 4, in an example where the X % likelihood is a 75% likelihood, and an example threshold value of 70% is used, the post-processing logic 406 may determine that the given data object corresponds to a substitution request. On the other hand, in an example where the X % likelihood is a 75% likelihood, and an example threshold value of 80% is used, the post-processing logic 406 may function to determine that the given data object does not correspond to a substitution request. Other examples of the post-processing logic 406 for the data science model 400 are possible as well.

As mentioned, the data science model 400 may be created using any of various machine learning techniques. As one possibility, the data science model 400, taking the form of a classification model, may be created using any of various supervised learning techniques, examples of which may include a neural network technique (which is sometimes referred to as “deep learning”), a regression technique (e.g., logistic regression), a k-Nearest Neighbor (kNN) technique, a decision-tree technique (e.g., random forest), a support vector machines (SVM) technique, and/or a Bayesian technique, among other examples. As another possibility, instead of a classification model, the data science model 400 may be created using any of various unsupervised machine learning techniques, such as clustering techniques, among various other examples. As yet another possibility, the data science model 400 may be created using any of various self-supervised learning techniques, such as a contrastive learning technique, and/or a Word2Vec technique, among various other examples. In practice, the data science model 400 may be created using any of various other techniques as well, and may include components of various techniques, such as (i) one or more supervised learning techniques, (ii) one or more unsupervised learning techniques, and/or (iii) one or more self-supervised learning techniques.

As another possibility, the data analytics carried out by the back-end computing platform 102 to determine whether the obtained data objects correspond to a substitution request may be embodied in the form of a user-defined set of rules that is applied to the obtained data objects (and more particularly, to each data object's data values) in order to determine, on an object-by-object basis, whether a given data object corresponds to a substitution request. In general, any suitable rule(s) to determine whether a given data object corresponds to a substitution request may be utilized. As an illustrative example, using an “RFI” data object, a rule may be that if the “RFI” data object includes a question field with text data indicative of a substitution request, such as “request for alternative materials,” “substitute material,” or the like, then that “RFI” data object corresponds to a substitution request. As another illustrative example, using a “submittal” data object, a rule may be that if the “submittal” data object includes a Description field with text data indicative of a substitution request, such as “request for alternative materials,” “substitute material,” or the like, then that “submittal” data object corresponds to a substitution request. Other examples are possible as well.

As mentioned above, there may be a plurality of types of data objects related to construction projects. In some examples, the specific data analytics utilized to determine whether a given data object corresponds to a substitution request may vary for different types of data objects. As one possibility, the data analytics carried out for a first data-object type (or a first set of data-object types) may be different than the data analytics carried out for a second data-object type (or a second set of data-object types). For instance, the data analytics carried out for a first data-object type (or a first set of data-object types) may take the form of a user-defined set of rules, whereas the data analytics carried out for a second data-object type (or a second set of data-object types) may take the form of a data science model.

As another possibility, in situations where the data analytics carried out take the form of a data science model such as the data science model 400, the data science model used for a first data-object type (or a first set of data-object types) may be different than the data science model used for a second data-object type (or a second set of data-object types), and so on. For instance, the data science model used for the first data-object type may comprise a first machine learning model (or a first set of machine learning models) that is trained using historical data objects of the first data-object type (which may have a first set of data fields), whereas the data science model used for the second data-object type may comprise a second machine learning model (or a second set of machine learning models) that is trained using historical data objects of the second data-object type (which may have a second set of data fields that differs from the first set), and so on. As an illustrative example, a first data science model may be used for an “RFI” data object, whereas a second data science model may be used for a “submittal” data object. Along similar lines, the pre-processing logic that is included and/or associated with a data science model may be different for different data-object types (e.g., a first set of pre-processing logic for a first data-object type, a second set of pre-processing logic for a second data-object type, and so on). Other examples are possible as well.

Further, in situations where the data analytics carried out take the form of a user-defined set of rules, the user-defined set of rules may be a global set of rules that is applied to all different types of data objects. In other examples, there could be multiple different sets of rules that are specific to different data-object types. For instance, the set of rules used for a first data-object type (or a first set of data-object types) may be different than the set of rules for a second data-object type (or a second set of data-object types), and so on. As an illustrative example, a first set of rules may be used for an “RFI” data object, whereas a second set of rules may be used for a “submittal” data object. Other examples are possible as well.

3. Identification of Topics Associated with Data Objects

Returning to FIG. 3, at block 306, the back-end computing platform 102 may, for each data object of the substitution-request-specific subset, evaluate the given data object and thereby identify one or more topics associated with the given data object.

In practice, there may be various topics that may be associated with a data object. As one possibility, these topics may describe types of construction-related items that are being requested to be replaced with substitute construction-related items, for example, via substitution requests. These topics may also be referred to herein as “originally-planned construction-related item topics.” Generally speaking, these topics may include one or more topics in various categories, such as a plurality of plumbing-specific topics, a plurality of electrical-specific topics, a plurality of carpentry-specific topics, and so on. Various other topics may also exist, some of which are described in greater detail below.

The back-end computing platform 102 may identify the one or more topics associated with the given data object in various manners. As one possibility, the back-end computing platform 102 may utilize one or more data analytics operations that serve to analyze data objects of the substitution-request-specific subset across the different types of data objects and/or tools in order to determine one or more topics associated with each of the data objects of the substitution-request-specific subset. Such a data analytics operation may be performed on an object-by-object basis and may take various forms.

As one possibility, the data analytics carried out by the back-end computing platform 102 to determine one or more topics (e.g., originally-planned construction-related item topics) associated with each of the data objects of the substitution-request-specific subset may be embodied in the form of one or more data science models that are each configured to determine, on an object-by-object basis, which topics are associated with a given data object. In an example, such a data science model may take the form of one or more machine learning models created using various machine learning techniques, one example machine learning model being a multi-class classification model.

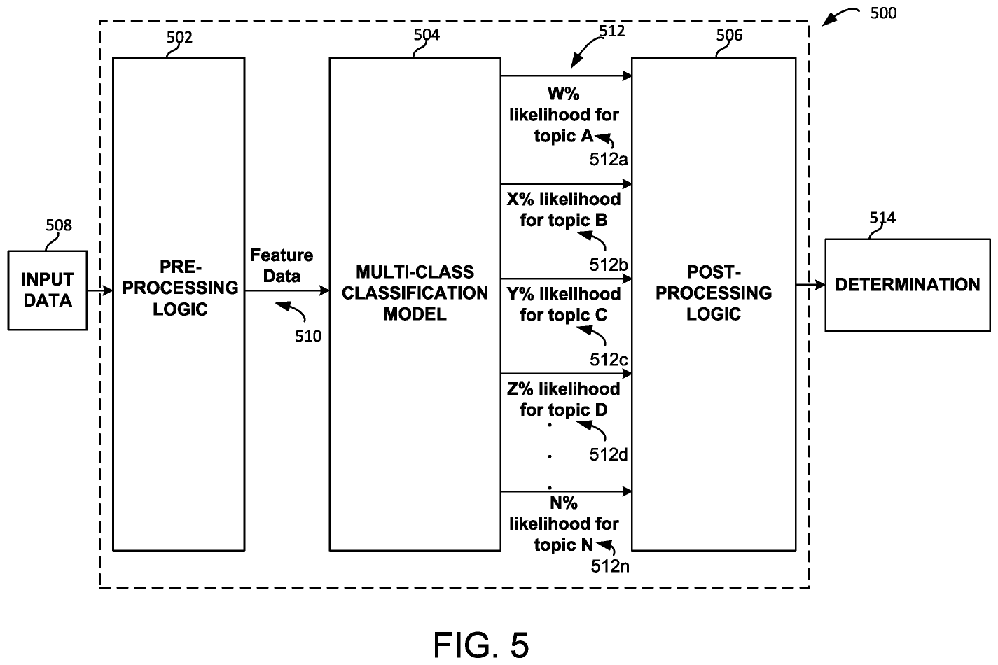

In this regard, FIG. 5 depicts a conceptual illustration of an example of a data science model 500 for predicting the one or more topics to which a given data object corresponds that comprises pre-processing logic 502, a multi-class classification model 504, and post-processing logic 506. At a high level, the pre-processing logic 502 may function to (i) receive input data 508 for a given data object of the substitution-request-specific subset and (ii) transform the input data 508 for the given data object into feature data 510 for the given data object, which is then provided as input to the multi-class classification model 504. In turn, the multi-class classification model 504 may be configured to (i) receive the feature data 510 for the given data object as input, (ii) evaluate the feature data 510 for the given data object, and (iii) based on the evaluation of the feature data 510, determine and output predictions 512 that each take the form of predicted likelihood that the given data object corresponds to a given topic. In turn, the post-processing logic 506 (e.g., a likelihood-percentage threshold) may function to evaluate the predictions 512 and then determine which topic(s), if any, to which the given data object corresponds. These aspects of the data science model 500 will now be described in greater detail.

The input data 508 for the given data object that is input into the data science model 500 may generally comprise any data that may be utilized to produce the feature data 510 for the given data object and may take any of various forms. In an example, the input data 508 may include all the data values associated with the given data object. In another example, the input data 508 may include a subset of the data values associated with the given data object. For instance, in practice, certain data values associated with the given data object (e.g., data values in certain data fields) may have more influence or weight (compared to other data values) with respect to determining which topic(s), if any, the given data object corresponds to, in which case the multi-class classification model 504 may be configured to receive and evaluate only a subset of the data values for the given data object. As an illustrative example using an “RFI” data object having the data fields discussed above, rather than the input data 508 including all of the data values for each data field of an “RFI” data object, the input data 508 may include a subset of the data values for the “RFI” data object, such as the data values for the data fields of “Question(s)” and “Response(s).” Other examples are possible as well.

As noted above, the input data 508 for the given data object may be received by the pre-processing logic 502 of the data science model 500, which may function similar to the pre-processing logic 402 described with respect to FIG. 4, with the exception that the pre-processing logic 502 may transform the input data 508 into the feature data 510 for the given data object rather than the feature data 410, wherein the feature data 510 for the given data object may generally comprise data for any feature variables that may facilitate a prediction of which topic(s), if any, to which the given data object corresponds. This feature data 510—and the pre-processing logic 502 that produces the feature data 510—may take any of various forms.

As one possibility, the pre-processing logic 502 may take the form of Natural Language Processing (“NLP”) logic that performs NLP techniques to analyze data values associated with the data object and translate those data values into the feature data 510, similar to the NLP techniques described with respect to the pre-processing logic 402, with the exception that the pre-processing logic 502 may look for phrases such as “material” or any phrase that describes a construction-related item in (i) for an “RFI” data object, the “Question(s)” and/or “Response(s)” data fields, and (ii) for a “submittal” data object, the “Description” data field, as such language may be indicative of one or more topics. The pre-processing logic 402 may also look for various other phrases as well. Further, this matching may include a fuzziness component that looks for synonyms or near-match phrases.

As another possibility, there may be one or more additional machine learning models as part of the pre-processing logic 502. For instance, the pre-processing logic 502 may use a pre-trained topic model, such as a BERTopic model, as previously described with respect to the pre-processing logic 402 of FIG. 4. The pre-processing logic 502 may take various other forms as well.

In line with the discussion above, the multi-class classification model 504 is configured to receive the feature data 510 for the given data object, evaluate the feature data 510, and then based on the evaluation, output predictions 512 that each take the form of predicted likelihood that the given data object corresponds to a respective topic of the originally-planned construction-related item topics. For instance, as shown in FIG. 5, the multi-class classification model 504 may output (1) a first prediction 512a that takes the form of a predicted likelihood that the given data object corresponds to a first topic A (e.g., steel), which is shown in FIG. 5 as W %, (2) a second prediction 512b that takes the form of a predicted likelihood that the given data object corresponds to a second topic B (e.g., piping), which is shown in FIG. 5 as X %, (3) a third prediction 512c that takes the form of a predicted likelihood that the given data object corresponds to a third topic C (e.g., a refrigerator), which is shown in FIG. 5 as Y %, (4) a fourth prediction 512d that takes the form of a predicted likelihood that the given data object corresponds to a fourth topic D (e.g., an excavator), which is shown in FIG. 5 as Z %, and so forth through (N) an Nth prediction 512n that takes the form of a predicted likelihood that the given data object corresponds to an Nth topic N (e.g., douglas fir beams), which is shown in FIG. 5 as N %. However, the predictions output by the multi-class classification model 504 may take other forms as well.

In turn, the post-processing logic 506 of the data science model 500 may function to evaluate the predictions 512 output by the multi-class classification model 504 in order to reach a determination 514 as to which topic(s), if any, to which the given data object corresponds. This post-processing logic 506 may take various forms.

As one possibility, the post-processing logic 506 may function to identify the one given topic for which the data object has the highest predicted likelihood of correspondence, and then determine that the given data object corresponds to that one given topic. For instance, in an example where W % likelihood is a 75% likelihood, X % likelihood is a 65% likelihood, Y % likelihood is a 45% likelihood, Z % likelihood is a 25% likelihood, and N % likelihood is a 5% likelihood, the post-processing logic 506 may function to determine that the given data object corresponds to topic A only.

As another possibility, the post-processing logic 506 may function to identify any topic(s) for which the given data object has a predicted likelihood of correspondence that satisfies a threshold value and then determine that the given data object corresponds to each identified topic (if any). The threshold value may be any suitable threshold, such as any threshold percentage likelihood of at least 50%. With reference to FIG. 5, in an example where W % likelihood is a 75% likelihood, X % likelihood is a 65% likelihood, Y % likelihood is a 45% likelihood, Z % likelihood is a 25% likelihood, N % likelihood is a 5% likelihood, and an example threshold value of 60% is used, the post-processing logic 506 may function to determine that the data object corresponds to both topics A and B.

As yet another possibility, the post-processing logic 506 may function to identify the one given topic for which the given data object has the highest predicted likelihood of correspondence and then either (i) determine that the given data object corresponds to the one given topic if the predicted likelihood satisfies a threshold value, or (ii) determine that the given data object does not correspond to any topic if the predicted likelihood does not satisfy the threshold value. With reference to FIG. 5, in an example where W % likelihood is a 75% likelihood, X % likelihood is a 65% likelihood, Y % likelihood is a 45% likelihood, Z % likelihood is a 25% likelihood, N % likelihood is a 5% likelihood, and an example threshold value of 70% is used, the post-processing logic 506 may determine that the given data object corresponds to topic A. On the other hand, in an example where W % likelihood is a 75% likelihood, X % likelihood is a 65% likelihood, Y % likelihood is a 45% likelihood, Z % likelihood is a 25% likelihood, N % likelihood is a 5% likelihood, and an example threshold value of 80% is used, the post-processing logic 506 may function to determine that the given data object does not correspond to any particular topic. Other examples of the post-processing logic 506 for the data science model 500 are possible as well.

As mentioned, the data science model 500 may be created using any of various machine learning techniques, similar to the data science model 400 described with respect to FIG. 4. Accordingly, the data science model 500 may be created using (i) one or more supervised learning techniques, (ii) one or more unsupervised learning techniques, and/or (iii) one or more self-supervised learning techniques, among various other possibilities.

As another possibility, the data analytics carried out by the back-end computing platform 102 to determine one or more topics that are associated with the data objects of the substitution-request-specific subset may be embodied in the form of a user-defined set of rules that is applied to the data objects of the substitution-request-specific subset (and more particularly, to each data object's data values) in order to determine, on an object-by-object basis, which topic(s), if any, to which a given data object corresponds. In practice, the user-defined set of rules may be similar to the user-defined set of rules previously described with respect to block 304, with the exception that the rules in this user-defined set of rules may be that if a data object includes text data indicative of a given topic, then that data object corresponds to the given topic.

As there may be various types of data objects related to construction projects, the specific data analytics utilized to determine which topic(s), if any, correspond to a given data object may vary for different types of data objects, as previously described with respect to the specific data analytics utilized to determine whether a given data object corresponds to a substitution request.

Another possible manner in which the back-end computing platform 102 may identify one or more topics associated with the data objects of the substitution-request-specific subset may include analyzing data objects of the substitution-request-specific subset to identify respective secondary resources from which to identify the one or more topics. The secondary resources may take any of various forms, and examples include, for a given data object of the substitution-request-specific subset, a specification sheet or drawings for the given construction project associated with the given data object.

The back-end computing platform 102 may identify secondary resources in any of various ways and, in some examples, the way to identify secondary resources may differ for different types of data objects. For example, to identify a secondary resource for a “submittal” data object, the back-end computing platform 102 may analyze data fields of the data object to identify a given data field that includes a link to or otherwise identifies the secondary resource. For example, the back-end computing platform 102 may analyze a “Specification section” data field and/or a “Linked Drawings” data field of the “submittal” data object to identify a secondary resource comprising a specification sheet and/or a secondary resource comprising a drawing. In the event that the back-end computing platform 102 does not find any such data field, the back-end computing platform 102 may instead analyze other data fields, such as a “Description” data field, to identify an indication of a secondary resource, for example, by utilizing NLP techniques as described above. The back-end computing platform 102 may identify secondary resources for “submittal” data objects in various other manners as well.

The back-end computing platform 102 may identify a secondary resource for an “RFI” data object in a manner that is similar to the manner in which the back-end computing platform 102 identifies a secondary resource for a “submittal” data object. For example, the back-end computing platform 102 may analyze a “Specification section” data field and/or a “Linked Drawings” data field of the “RFI” data object to identify a secondary resource comprising a specification sheet and/or a secondary resource comprising a drawing. However, although “RFI” data objects may include data fields such as “Linked Drawing(s)” and “Specification Section,” in practice, these data fields may rarely be filled in. Accordingly, the back-end computing platform 102 may instead analyze other data fields, such as a “Question(s)” and or “Response(s)” data field, to identify an indication of a secondary resource, for example, by utilizing NLP techniques as described above. The back-end computing platform 102 may identify secondary resources for “RFI” data objects in various other manners as well.

After identifying one or more secondary resources for a given data object of the substitution-request-specific subset, the back-end computing platform 102 may then analyze the one or more secondary resources to identify one or more topics associated with the data object. For example, a specification section may reference one or more construction-related items that are ordered (or to be ordered) for a given construction project, and the back-end computing platform 102 may identify one or more topics at least partially based on the one or more construction-related items that are referenced in the specification section. The back-end computing platform 102 may identify one or more topics from linked drawings in a similar manner.

In some implementations, the back-end computing platform 102 may determine one or more topics that are associated with a given data object in a first manner, and other topics that are associated with the given data object in other manners. To illustrate with an example, the back-end computing platform 102 may begin by identifying one or more secondary resources associated with the given data object. The back-end computing platform 102 may then analyze the one or more secondary resources to determine one or more topics that are associated with the given data object. However, in this example, the one or more secondary resources may not include topic information for one or more topics that the back-end computing platform 102 may identify utilizing other methods, such as the data science model 500 or the user-defined set of rules previously described. Accordingly, the back-end computing platform 102 may then utilize the data science model 500 or the user-defined set of rules as previously described to identify one or more additional topics that are associated with the given data object. Various other possibilities may also exist.

Further, the back-end computing platform 102 may memorialize the one or more identified topics in preparation for further analysis (e.g., to determine one or more supply-related issues). As one possibility, the back-end computing platform 102 may memorialize the one or more identified topics by assigning one or more labels to each data object to indicate the one or more topics that are associated with the data object. In an example where a given data object corresponds to a “steel” topic, the back-end computing platform 102 may assign a “steel” label to the given data object to indicate the identified “steel” topic that corresponds to the given data object. As another example, a given data object may correspond to a “piping” topic, and the back-end computing platform 102 may assign a “piping” label to the given data object to indicate the identified “piping” topic that corresponds to the given data object. As yet another example, a given data object may correspond to both a “concrete” topic and a “piping” topic, and the back-end computing platform 102 may assign a “concrete” label and a “piping” label to the given data object to indicate the identified “concrete” and “piping” topics that correspond to the given data object.

As another possibility, the back-end computing platform 102 may memorialize the one or more identified topics by storing data objects in one or more databases that correspond to respective topics. For example, the back-end computing platform 102 may store data objects that correspond to a first topic in a first database or a first folder in the first database, and data objects that correspond to a second topic in a second database or a second folder in the first database. In instances where a given data object corresponds to more than one topic, the back-end computing platform 102 may store the data object in each of a plurality of databases. The back-end computing platform 102 may memorialize the one or more identified topics in various other ways as well.

### 4. Determination of Supply-Related Issues

Returning to FIG. 3, at block 308, the back-end computing platform 102 may, based at least on the identified one or more topics associated with the data objects of the substitution-request-specific subset, determine one or more supply-related issues. As previously described, these supply-related issues may include supply-chain issues for given construction-related items, cost-related issues for given construction-related items, and/or quality-related issues for given construction-related items, among various other possibilities. In some examples, the back-end computing platform 102 may, based at least on the identified one or more topics associated with the data objects of the substitution-request-specific subset, determine a plurality of supply-related issues. In practice, the back-end computing platform may analyze a large number of data objects (e.g., on the order of hundreds, thousands, tens of thousands, etc.), and there may be numerous supply-related issues that may be determined based on that analysis. However, in other examples, the back-end computing platform 102 may, based at least on the identified one or more topics associated with the data objects of the substitution-request-specific subset, determine a single supply-related issue.

In practice, the back-end computing platform 102 may determine the plurality of supply-related issues by identifying upticks in substitution requests that correspond to given topics. The back-end computing platform 102 may identify an uptick by comparing substitution requests that correspond to a given topic with a baseline amount of substitution requests.

As one possibility, the back-end computing platform 102 may compare the substitution requests that correspond to a given topic with a baseline amount of substitution requests for other topics or categories of topics that may be similar to the given topic. To illustrate with an example, the back-end computing platform 102 may compare (i) the substitution requests that correspond to a “douglas fir wooden beam” topic with (ii) a baseline amount of substitution requests for any type of wooden beam. In such an example, the back-end computing platform 102 may determine that there is typically a 10% rate of substitution requests for wooden beams, but that there has been a 70% rate of substitution requests to replace douglas fir wooden beams with a different type of wooden beam for the past two months. Accordingly, in this example, the back-end computing platform 102 may determine that there is an uptick in substitution requests for douglas fir wooden beams and thus there is a supply-related issue for douglas fir wooden beams.

As another possibility, the back-end computing platform 102 may compare the substitution requests that correspond to a given topic with a baseline amount of substitution requests for other topics that are associated with a given trade with which the given topic is also associated. A trade may generally refer to a type of work that is performed in relation to construction projects. Example trades may include: (i) Architectural, (ii) Civil, (iii) Demolition, (iv) Electrical, (v) Fire Protection, (vi) Food Service, (vii) General, (viii) Garage Architectural, (ix) Garage Electrical, (x) Garage Mechanical, (xi) Garage Plumbing, (xii) Garage Structural, (xiii) Hazardous Materials, (xiv) Interior, (xv) Landscape, (xvi) Lighting, (xvii) Mechanical, (xviii) Plumbing, (xix) Equipment, (xx) Resource, (xxi) Structural, (xxii) Telecommunications, (xxiii) Other, and (xxiv) Contractor/Shop Drawings, among various other trades.

To illustrate with an example, the back-end computing platform 102 may compare (i) the substitution requests that correspond to a “copper piping” topic with (ii) a baseline amount of substitution requests for other construction-related items related to the “Plumbing” trade. In some implementations, the baseline amount may be for (i) all topics related to the “Plumbing” trade or (ii) a subset of the topics related to the “Plumbing” trade that are related to the given topic (e.g., other types piping, such as polyvinyl chloride (PVC) piping, brass piping, cast iron piping, etc.). In such an example, the back-end computing platform 102 may determine that there is typically a 10% rate of substitution requests for construction-related items related to the “Plumbing” trade, but that there has been a 70% rate of substitution requests to replace copper piping with different types of piping for the past two months. Accordingly, in this example, the back-end computing platform 102 may determine that there is an uptick in substitution requests for copper piping and thus there is a supply-related issue for copper piping.

The back-end computing platform 102 may identify the uptick in various other ways as well, including by comparing the substitution requests that correspond to given topics with various other baselines as well.

In practice, the supply-related issues that the back-end computing platform 102 may determine at block 308 may include supply-related issues for various construction-related items. For instance, the one or more supply-related issues may comprise (i) a first supply-related issue for a first construction-related item, (ii) a second supply-related issue for a second construction-related item, (iii) a third supply-related issue for a third construction-related item, (iv) a fourth supply-related issue for a fourth construction-related item, and so forth. For example, the back-end computing platform 102 may determine these supply-related issues based at least partially on identifying respective upticks in substitution requests corresponding, respectively, to (i) a first topic representing the first construction-related item, (ii) a second topic representing the second construction-related item, (iii) a third topic representing the third construction-related item, (iv) a fourth topic representing the fourth construction-related item, and so forth.

Further, in practice, the back-end computing platform 102 may determine additional information about the data objects of the substitution-request-specific subset that may be used along with the identified topics to determine the one or more supply-related issues and/or to determine more information about the one or more supply-related issues. The additional information about the data objects may be referred to herein as “additional topics.”

These additional topics may take various forms. As one possibility, additional topics that the back-end computing platform 102 may be configured to determine may be related to types of construction-related item that are being ordered as substitute construction-related items in place of originally-planned construction-related items (which the “originally-planned construction-related item topics described with respect to block 306 may be related to). These additional topics may be referred to herein as “substitute construction-related item topics.”

As another possibility, additional topics that the back-end computing platform 102 may be configured to determine may be related to original providers of construction-related items. These additional topics may be referred to herein as “originally-planned provider topics.”

As yet another possibility, additional topics that the back-end computing platform 102 may be configured to determine may be related to substitute providers of construction-related items. These additional topics may be referred to herein as “substitute provider topics.”

As still yet another possibility, additional topics that the back-end computing platform 102 may be configured to determine may be related to relative costs associated with respective substitution requests. For example, an original order referenced in a substitution request (e.g., for an originally-planned construction-related item from an originally-planned provider) may be associated with a first cost, and a substitute order referenced in the substitution request (e.g., for a construction-related item, either originally-planned or substitute, from a provider, either originally-planned or substitute) may be associated with a second cost, and a difference between these costs may be a respective cost associated with the substitution request. These additional topics may be referred to herein as “relative cost topics.”

As yet another possibility, additional topics that the back-end computing platform 102 may be configured to determine may be related to relative delivery timelines associated with respective substitution requests. For example, an original order referenced in a substitution request (e.g., for an originally-planned construction-related item from an originally-planned provider) may be associated with a first delivery timeline, and a substitute order referenced in the substitution request (e.g., for a construction-related item, either originally-planned or substitute, from a provider, either originally-planned or substitute) may be associated with a second delivery timeline (e.g., a quicker delivery time than the first delivery timeline), and a difference between these delivery timeline may be a respective delivery timeline associated with the substitution request. These additional topics may be referred to herein as “relative delivery timeline topics.”

In practice, the back-end computing platform 102 may determine these additional topics in the same or similar manner described with respect to FIG. 5. Further, there may be various other additional topics that the back-end computing platform 102 may be configured to determine.

As mentioned above, the back-end computing platform 102 may utilize these additional topics along with the topics identified at block 306 to determine the one or more supply-related issues and/or to determine more information about the one or more supply-related issues.

In an example, the back-end computing platform 102 may determine that a supply-related issue exists based on the identified “originally-planned construction-related item” topics of the substitution-request specific subset (e.g., by identifying an uptick in substitution requests corresponding to a given “originally-planned construction-related item” topic), and then the back-end computing platform 102 may determine more information about the identified supply-related issue by utilizing these additional topics. For instance, as one possibility, the back-end computing platform 102 may determine additional details that describe a type of a given supply-related issue of the one or more supply-related issues.

As previously described, one type of supply-related issue may be a supply-chain issue. Accordingly, the back-end computing platform 102 may, using the various topics (including the additional topics described above) associated with data objects of the substitution-request-specific subset, determine that the given supply-related issue is a supply-chain issue. More specifically, the back-end computing platform 102 may determine that the given supply-related issue is (i) a provider-specific impending shortage of the given construction-related item, (ii) a wide-spread impending shortage of the given construction-related item for a plurality of providers of the given construction-related item, (iii) an availability of a substitute construction-related item purchasing opportunity to purchase a given construction-related item from a different provider of the construction-related item than originally planned to be ordered from, for example, for a more ideal delivery timeline, or (iv) an availability of a substitute construction-related item purchasing opportunity to purchase a given construction-related item from an originally-planned provider of the given construction-related item, for example, for a more ideal delivery timeline.

Further, as previously described, another type of supply-related issue may be a cost-related issue. Accordingly, the back-end computing platform 102 may, using the various topics (including the additional topics described above) associated with data objects of the substitution-request-specific subset, determine that the given supply-related issue is a cost-related issue. More specifically, the back-end computing platform 102 may determine that the given supply-related issue is (i) an availability of a substitute construction-related item purchasing opportunity to purchase an originally-planned construction-related item from a different provider of the construction-related item than originally planned to be ordered from, for example, for a reduced price, (ii) an availability of a substitute construction-related item purchasing opportunity to purchase a substitute construction-related item from a different provider of the construction-related item than originally planned to be ordered from, for example, for a reduced price, or (iii) an availability of a substitute construction-related item purchasing opportunity to purchase a substitute construction-related item from an originally-planned provider of an originally-planned construction-related item, for example, for a reduced price.

Further yet, and as previously described, another type of supply-related issue may be a quality-related issue. Accordingly, the back-end computing platform 102 may, using the various topics (including the additional topics described above) associated with data objects of the substitution-request-specific subset, determine that the given supply-related issue is a quality-related issue. More specifically, the back-end computing platform 102 may determine that the given supply-related issue is (i) an availability of a substitute construction-related item purchasing opportunity to purchase a substitute construction-related item from a different provider than originally planned to be ordered from, wherein the substitute construction-related item is of a higher quality than an originally-planned construction-related item, or (ii) an availability of a substitute construction-related item purchasing opportunity to purchase a substitute construction-related item from an originally-planned provider, wherein the substitute construction-related item is of a higher quality than an originally-planned construction-related item.

As another possibility, the back-end computing platform 102 may determine additional details that describe a temporal element for a given supply-related issue of the one or more supply-related issues. For example, if the back-end computing platform 102 determines that there is a supply-related issue comprising a supply-chain issue for a given construction-related item, that determination may include details such as (i) when the supply-chain issue for the given construction-related item is expected to begin, and (ii) how long the supply-chain issue for the given construction-related item is expected to last. As may be appreciated, there may be various other temporal elements that the back-end computing platform 102 may determine for one or more supply-related issues that the back-end computing platform 102 may identify.

As yet another possibility, the back-end computing platform 102 may determine additional details that describe an underlying reason for a given supply-related issue of the one or more supply-related issues. For instance, after determining a given supply-related issue for a given construction-related item, the back-end computing platform 102 may perform an additional analysis on the data objects that correspond to an “originally-planned construction-related item” topic referencing the given construction-related item, which may be similar to one or more of the analyses described with respect to block 306. Based on this additional analysis, the back-end computing platform 102 may identify one or more additional topics that may be related to an underlying reason for the given supply-related issue for the given construction-related item.

As an illustrative example, the given supply-related issue may be a supply-chain issue for a given type of refrigerator, and the additional analysis may reveal that data objects of the substitution-request-specific subset that correspond to an “originally-planned construction-related item” topic referencing the given type of refrigerator also commonly mention a “chip” or “chip issue.” For instance, a threshold percentage (e.g., 50% or more) of the data objects of the substitution-request-specific subset that correspond to the topic of the given type of refrigerator may reference a “chip” or “chip issue.” Therefore, in such an example, the back-end computing platform 102 may determine that the data objects of the substitution-request-specific subset that correspond to the topic of the given type of refrigerator may also correspond to a topic of “chip.” In such an example, the back-end computing platform 102 may determine that the underlying reason for the supply-chain issue for the given type of refrigerator is a chip issue (e.g., chip shortage) for a chip that is included in the given type of refrigerator.

As may be appreciated, there may be various other underlying reasons for supply-related issues that the back-end computing platform 102 may be configured to determine, as well as various other manners in which the back-end computing platform 102 may determine underlying reasons for supply-related issues. For example, in some implementations, the back-end computing platform 102 may determine underlying reasons based on other criteria, such as data objects of the substitution-request-specific subset that correspond to any of the additional topics described above, among various other possibilities.

As still yet another possibility, the back-end computing platform 102 may determine additional details that describe a respective reputation for one or more providers of construction-related items. For example, the back-end computing platform 102 may determine that a given provider of construction-related items has a reputation of being reliable based on there being a small amount of data objects in the substitution-request-specific subset that correspond to an “originally-planned provider” topic that references the given provider.

As still yet another example, the back-end computing platform 102 may determine that a given provider of construction-related items has a reputation of being a preferred provider for certain construction-related items based on there being a large amount of data objects in the substitution-request-specific subset that correspond to a “substitute provider” topic that references the given provider. The back-end computing platform 102 may also make this determination based on there being a small amount of data objects in the substitution-request-specific subset that (i) correspond to an “originally-planned provider” topic that references the given provider and (ii) correspond to a “substitute provider” topic that reference another provider, among other possibilities.

As yet another example, the back-end computing platform 102 may determine that a given provider of construction-related items has a reputation for being unsatisfactory to customers of the given provider. The back-end computing platform 102 may make this determination based on there being a small amount of data objects in the substitution-request-specific subset that correspond to (i) an “originally-planned provider” topic that references the given provider and (ii) a “substitute provider” topic that references a different provider, particularly when said data objects do not correspond to any “substitute construction-related item” topics. Various other examples of reputations that the back-end computing platform 102 may determine for a provider of construction-related items may also exist.

The additional details that the back-end computing platform 102 may determine may take any of various other forms as well.

### 5. Identification of Construction Project Likely to be Impacted by Determined Supply-Related Issues

Returning to FIG. 3, at block 310 the back-end computing platform 102 may identify a given construction project that has a likelihood of being impacted by one or more of the plurality of supply-related issues that the back-end computing platform 102 identified at block 308.

In practice, the back-end computing platform 102 may identify a given construction project that has a likelihood of being impacted by one or more of the plurality of supply-related issues in various ways. In an example, the back-end computing platform 102 may analyze a pool of construction projects to identify a given construction project that has a likelihood of being impacted by one or more of the supply-related issues. For instance, the back-end computing platform 102 may analyze, for each construction project of the pool of construction projects, data objects related to the construction project to determine whether the construction project involves construction-related items that are associated with any of the determined supply-related issues. Further, in an example, if a construction project involves construction-related items that are associated with any of the determined supply-related issues, the back-end computing platform 102 may identify that given construction project as having a likelihood of being impacted by one or more of the plurality of supply-related issues. As an illustrative example, if a construction project has a data object indicating that the construction project involves an order for “concrete,” and the back-end computing platform 102 has determined a supply-related issue comprising a supply-chain issue for concrete, then the back-end computing platform 102 may determine that given construction project has a likelihood of being impacted by one or more of the plurality of supply-related issues.

In some examples, a given construction project may have a likelihood of being impacted by numerous issues of the identified supply-related issues.

In some examples, the back-end computing platform 102 may determine that the given construction project has a likelihood of being impacted by the one or more supply-related issues based on a temporal alignment between a construction-related item associated with the given construction project and the one or more supply-related issues.

To illustrate an example where there is a temporal alignment, an example construction project may involve a given construction-related item, which in this example may be a given type of windowpane. Further, an example supply-related issue determined by the back-end computing platform 102 may comprise a supply-chain issue for the given type of windowpane. The back-end computing platform 102 may have also determined that the example supply-chain issue for the given type of windowpane is expected to be in effect for a given period of time (e.g., 1-2 months), which may impact the example given construction project. For instance, the example given construction project may be scheduled to install the windowpanes within the next three weeks. Accordingly, based on there being a temporal alignment between a construction-related item associated with the given construction project and the supply-chain issue for the given type of windowpane, the back-end computing platform 102 may determine that the given construction project has a likelihood of being impacted by the supply-chain issue for the given type of windowpane.

To illustrate an example where there is not a temporal alignment, an example construction project may involve a given construction-related item, which in this example may be a given type of roofing shingle. Further, an example supply-related issue determined by the back-end computing platform 102 may comprise a supply-chain issue for the given type of roofing shingle. The back-end computing platform 102 may have also determined that the example supply-chain issue for the given type of roofing shingle is expected to be in effect for a given period of time (e.g., 1-4 weeks). In this example, the supply-chain issue may not impact the example given construction project. For instance, the example given construction project may not be scheduled to install the roofing shingle for another four (4) months. As such, despite the example construction project involving a construction-related item that is associated with the example supply-chain issue, the example construction project may nonetheless not be likely to be impacted by the example supply-chain issue. Other examples are possible as well.

In an example, prior to identifying a given construction project that has a likelihood of being impacted by one or more of the plurality of supply-related issues, the back-end-computing platform may receive a request to determine whether a given construction project may be subject to any supply-related issues. For instance, the back-end computing platform 102 may receive a message from a client station that is capable of accessing the SaaS application hosted by the back-end computing platform 102 that indicated a request to determine whether a given construction project may be subject to any supply-related issues. For example, a user of the client station may wish to provide an identity of a construction project to the back-end computing platform 102 to trigger an analysis of whether a given construction project may be subject to any supply-related issues. In response to the request, the back-end computing platform 102 may analyze the given construction project to determine whether the given construction project has a likelihood of being impacted by one or more of the plurality of supply-related issues. Further, if the determination is in the affirmative, the back-end computing platform 102 may identify the given construction project as being a construction project that has a likelihood of being impacted by one or more of the plurality of supply-related issues.

The back-end computing platform 102 may determine the given construction project that has a likelihood of being impacted by one or more supply-related issues in various other ways as well.

### 6. Determination of Insights for Construction Project Using Determined Supply-Related Issues

At block 312, the back-end computing platform 102 may determine one or more insights for the given construction project based at least on the one or more of the plurality of supply-related issues. In practice, the insights determined by the back-end computing platform 102 may take any of various forms.

One possible insight for the given construction project may include a notification that the given construction project involves a given construction-related item (or additional topic, such as a given provider) that is referenced by one or more supply-related issues.

Another possible insight for the given construction project may include a suggestion to submit a substitution request for a substitute construction-related item. As one example, if the back-end computing platform 102 determines that the given construction project is likely to be impacted by a supply-chain issue for a given construction-related item, then the back-end computing platform 102 may determine an insight comprising a suggestion to submit a substitution request to replace the given construction-related item with a substitute construction-related item. As another example, if the back-end computing platform 102 determines that there is a more advantageous purchasing opportunity for a substitute construction-related item (e.g., a substitute construction-related item is cheaper than the given construction-related item, a substitute construction-related item can be delivered sooner than the given construction-related item, etc.), then the back-end computing platform 102 may determine an insight comprising a suggestion to submit a substitution request to replace the given construction-related item with a substitute construction-related item. Various other examples may also exist.

Yet another possible insight for the given construction project may include a suggestion to submit a substitution request for a substitute provider. As one example, if the back-end computing platform 102 determines that the given construction project is likely to be impacted by a supply-related issue comprising an inability of an originally-planned provider of construction-related items to provide the construction-related items, then the back-end computing platform 102 may determine an insight comprising a suggestion to submit a substitution request to order any construction-related items originally planned to be ordered from the provider to instead be ordered from a substitute provider. As another example, if the back-end computing platform 102 determines that there is a more advantageous purchasing opportunity for certain construction-related items (either originally-planned or substitute), then the back-end computing platform 102 may determine an insight comprising a suggestion to submit a substitution request to take advantage of the more advantageous purchasing opportunity. As previously described, this may involve switching to ordering substitute construction-related items from a given provider, switching to order the same construction-related items from a substitute provider, or switching to order substitute construction-related items from a substitute provider. Various other examples may also exist.

Still yet another possible insight for the given construction project may include a suggestion that certain construction-related tasks be replanned in some way. To illustrate with an example, for a given construction project, a first task that requires a first construction-related item may be scheduled to be performed several weeks before a second task that requires a second construction-related item. In this example, the back-end computing platform 102 may determine a supply-chain issue for the first construction-related item for the period of time that the first task is scheduled to be performed, but not for the period of time that the second task is scheduled to be performed. Accordingly, the back-end computing platform 102 may determine an insight comprising a suggestion to reorder the tasks such that the second task is performed first, and the first task is performed second, so that the required construction-related items for each task are able to be provided in time. In such an example, the back-end computing platform 102 may take into consideration whether the tasks are able to be adjusted, for example, without negatively impacting other tasks of the given construction project. As may be appreciated, this example may extend to situations where a given organization has planned to complete a plurality of construction projects. In such instances, it may be possible for the back-end computing platform 102 to determine an insight comprising a suggestion to replan an order of completing construction projects of the plurality of construction projects. Various other examples may also exist.

Yet another possible insight for the given construction project may include a suggestion that one or more orders for construction-related items be placed for one or more construction projects planned to be fulfilled by a contractor planning to fulfill the given construction project. To illustrate with an example, the back-end computing platform 102 may determine a supply-chain issue for a given construction-related item that is likely to take effect at a certain future time. The back-end computing platform 102 may also identify one or more additional construction projects that the contractor planning to fulfill the given construction project is also planning to fulfill. Accordingly, the back-end computing platform 102 may determine whether any additional construction projects that the contractor is planning to fulfill are also likely to be impacted by the supply-chain issue for the given construction-related item. If so, then the back-end computing platform 102 may determine an insight comprising a suggestion to pre-order the given construction-related item for one or more of the additional construction projects, for example, in anticipation of the impending supply-chain issue. Various other examples may also exist.

Still yet another possible insight for the given construction project may include an indication of a respective reputation for one or more creators of substitution requests. As one example, the back-end computing platform 102 may determine that a given creator of substitution requests has a reputation for creating substitution requests for a more advantageous purchasing option for construction-related items. As another example, the back-end computing platform 102 may determine that a given creator has a reputation for creating substitution requests that are less than optimal, such as substituting for lower grade materials unnecessarily. As may be appreciated, there may be various other reputations that the back-end computing platform 102 may determine for a creator of substitution requests. Such an insight may be a construction-network insight that recommends a contractor that has a reputation for creating substitution requests for a more advantageous purchasing option for construction-related items.

Yet another possible insight for the given construction project may include an indication that a supply-related issue may be imminent for a given construction-related item, for example, based on an observed volume of orders for the given construction-related item in the recent past.

Further, in some implementations, insights for the given construction project determined by the back-end computing platform 102 may take into consideration any underlying reasons as to why certain supply-related issues are likely to impact the given construction project. There may be various other insights that the back-end computing platform 102 may determine for the given construction project as well.

### 7. Presentation of an Indication of One or More Insights

At block 314, the back-end computing platform 102 may transmit, to a client station, data defining the one or more insights for the given construction project and thereby cause an indication of the one or more insights to be presented at a user interface of the client station. In some implementations, the client station may be one of the client stations 112 of FIG. 1. In general, the client station may be a client station used by a user associated with the given construction project.

Further, as mentioned above, the back-end computing platform 102 may receive, from a client station, a request to determine whether a given construction project may be impacted by any supply-related issues. In some examples, the client station from which the request was received may be the same as the client station on which the indication of the one or more insights is presented. Alternatively, the client station on which the indication of the one or more insights is presented may be a first client station, and the client station from which the request was received may be a second, different client station. As one possibility, the first client station and the second client station may be different client stations associated with the same user. For instance, the first client station may be a computer of the user, and the second client station may be a phone of the user. As another possibility, the first client station may be a client station of a first user, and the second client station may be a client station of a different, second user. For instance, the first client station may be a client station used by a first user associated with the given construction project, and the second client station may be a client station of a second user associated with the given construction project. Other examples are possible as well.

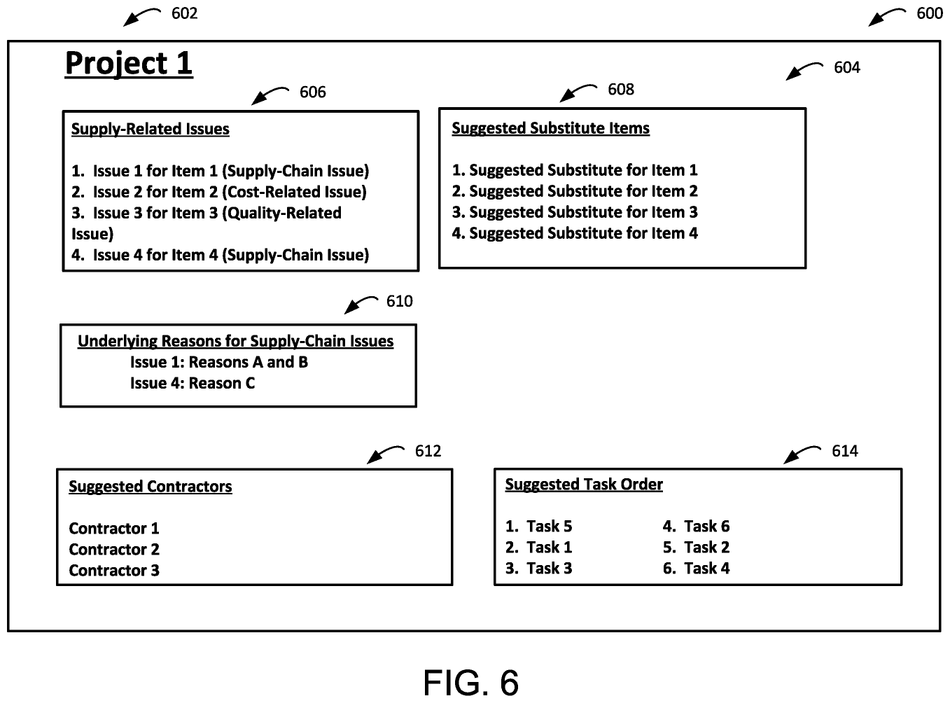

FIG. 6 depicts an example snapshot 600 of a GUI 602 that displays information regarding the one or more insights. GUI 602 includes an indication 604 of the one or more insights. In this example, the indication 604 comprises a plurality of indicators for different insights, including an indicator 606 for insights providing notification of supply-related issues for the construction project, an indicator 608 for insights related to suggested substitute items, an indicator 610 for insights related to underlying reasons for supply-chain issues, an indicator 612 for an insight related to suggested contractors, and an indicator 614 for an insight related to a suggested task order. Other examples are possible as well.

### D. Precursor Topic Space Identification

As described above, the back-end computing platform 102 may determine that data objects correspond to one or more topics as part of the operations described with respect to FIG. 3. Further, evaluating the data objects may involve evaluating the data objects with respect to predefined topics (including the additional topics described above) from a universe of available topics. The universe of available topics may be predefined in various ways.

As one possibility, a user may provide the back-end computing platform 102 with the universe of available topics. As another possibility, the back-end computing platform 102 may be configured to define topics of the universe of available topics, for example via operations such as those described with respect to block 306.

In some examples, prior to such evaluating data objects using supervised techniques, the back-end computing platform 102 may conduct an evaluation of data objects related to construction projects in order to uncover (or otherwise identify) one or more topics that may thereafter be added to the universe of available topics that may be utilized when evaluating data objects using supervised techniques.

As one possibility, using unsupervised techniques to cluster data objects into topics, the back-end computing platform 102 may analyze the data objects to determine what topics are surfacing, which may include already known topics and/or one or more yet unknown topics. The one or more yet unknown topics may be any topic identified based on the analysis, one example of which may be a “chip” topic. For instance, in an example, the predefined topics may not include a “chip” topic. However, an evaluation of data objects may reveal that a “chip” topic commonly occurs in some data objects related to the substitution requests, so the back-end computing platform 102 may add such a newly discovered topic to the list or predefined topics. Other examples are possible as well.

### E. Construction-Relevant Data

In addition to the operations described with respect to data objects related to construction projects (e.g., the operations described with respect to FIG. 3), the back-end computing platform 102 may be also configured to perform a number of operations with respect to construction-relevant data that is different than the data objects related to construction projects. In general, construction-relevant data may include data items that may originate and/or be obtained from various sources, such as news organizations, government agencies, construction-related organizations, and the like. The construction-relevant data may include information indicative of one or more supply-related issues. In some examples, construction-relevant data may be generated by one or more sources of data, and each source may be external to the organization that creates and stores the construction project data objects and project data objects as previously described.

F. Determining Insights for Construction Projects Based on Supply-Related Issues Identified from Construction-Relevant Data

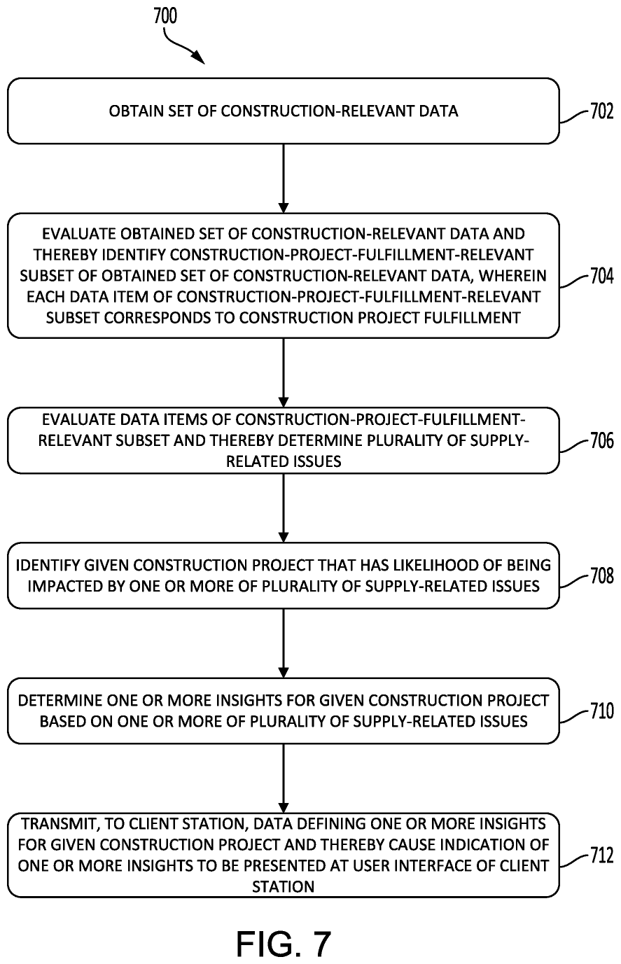

Accordingly, in FIG. 7, a flowchart 700 is shown, which illustrates one example of a process that may be carried out in accordance with the disclosed technology to facilitate the determination of one or more insights related to a new or ongoing construction project based on construction-relevant data (e.g., external data from various sources, such as news organizations, government agencies, construction-related organizations, and the like). For purposes of illustration only, the flowchart 700 is described as being carried out by the back-end computing platform 102 of FIG. 1, but it should be understood that the flowchart 700 may be carried out by computing platforms that take other forms as well. Further, it should be understood that, in practice, the functions described with reference to FIG. 7 may be encoded in the form of program instructions that are executable by one or more processors of the back-end computing platform 102. Further yet, it should be understood that the disclosed process is merely described in this manner for the sake of clarity and explanation and that the example embodiment may be implemented in various other manners, including the possibility that functions may be added, removed, rearranged into different orders, combined into fewer blocks, and/or separated into additional blocks depending upon the particular embodiment.

As described in more details below, the operations that the back-end computing platform 102 may perform with respect to construction-relevant data may in some instances be similar to the operations described with respect to FIG. 3.

### 1. Obtain Set of Construction-Relevant Data

Beginning at block 702, the back-end computing platform 102 may obtain a set of construction-relevant data, which may comprise a plurality of data items. As mentioned above, construction-relevant data may include data items that may originate and/or be obtained from various sources, such as news organizations, government agencies, construction-related organizations, and the like. The data items of the construction-relevant data may take various forms.

For instance, one type of data item that may be included in the set of construction-relevant data may be text-based construction-related data items. Data items of this type may include things such as news articles, documents released by a government agency, documents released by a construction-related organization (e.g., Associated General Contractors of America, National Association of Home Builders, Construction Industry Institute, etc.), certain social media content, databases comprising weather reports, and reports prepared by sources of data objects for construction projects, among various other possible data items that may be text-based.

Another type of data item that may be included in the set of construction-related data may be audio-based construction-related data items. Data items of this type may include things such as news reports, government agency press releases, certain social media content, weather reports, podcasts, and radio shows, among various other possible data items that may be audio-based.

Yet another type of data item that may be included in the set of construction-related data may be video-based construction-related data items. Data items of this type may include things such as news reports, government agency press releases, certain social media content, weather reports, video podcasts, and radio shows, among various other possible data items that may be video-based.

There may be various other types of data items that may be included in the set of construction-relevant data.

In practice, the back-end computing platform 102 may be triggered to obtain the set of construction-related data, for example, based on a request submitted by a user of a client station, such as described above, to perform operations of FIG. 7. As another example, the back-end computing platform 102 may be configured to obtain construction-relevant data from the one or more sources on a scheduled (e.g., periodic) basis, such as hourly, daily, or weekly, among other possibilities. Other possibilities may also exist.

### 2. Identification of Construction-Project-Fulfillment-Relevant Data Items

At block 704, the back-end computing platform 102 may evaluate the obtained set of construction-relevant data and thereby identify a construction-project-fulfillment-relevant subset of data items of the obtained set of construction-relevant data, wherein each data item of the construction-project-fulfillment-relevant subset corresponds to construction project fulfillment. As used herein, construction project fulfillment may refer to completing a given construction project. The back-end computing platform 102 may evaluate the obtained set of construction-relevant data and thereby identify a construction-project-fulfillment-relevant subset of data items of the obtained set of construction-relevant data in various ways. In this respect, block 704 is similar in many respects to block 304, and thus is not described in as great of detail. It should be understood, however, that many of the possibilities and permutations described with respect to block 304 may also be possible with respect to block 704.

Further, construction-relevant data items may have various portions, including, for instance, a title, a headline, an abstract, and/or a body, among other possibilities. In practice, it may be helpful to analyze certain portions of construction-relevant data items in order to narrow down the amount of data items that are to be analyzed further (e.g., to save on processing resources).

To this end, the back-end computing platform 102 may utilize one or more data analytics operations that serve to analyze respective first portions of data items of the set of construction-related data across the different types of data items in order to determine which of the data items of the set of construction-related data corresponds to construction project fulfillment. Such data analytics operations may be performed on an item-by-item basis and may take various forms.

As one possibility, the data analytics operations carried out by the back-end computing platform 102 to determine which of the obtained data items correspond to construction project fulfillment may be embodied in the form of one or more data science models that are each configured to determine, on an item-by-item basis, whether a data item corresponds to construction project fulfillment. In an example, such a data science model may take the form of one or more machine learning models created using a supervised machine learning technique, one example of which is a classification model.

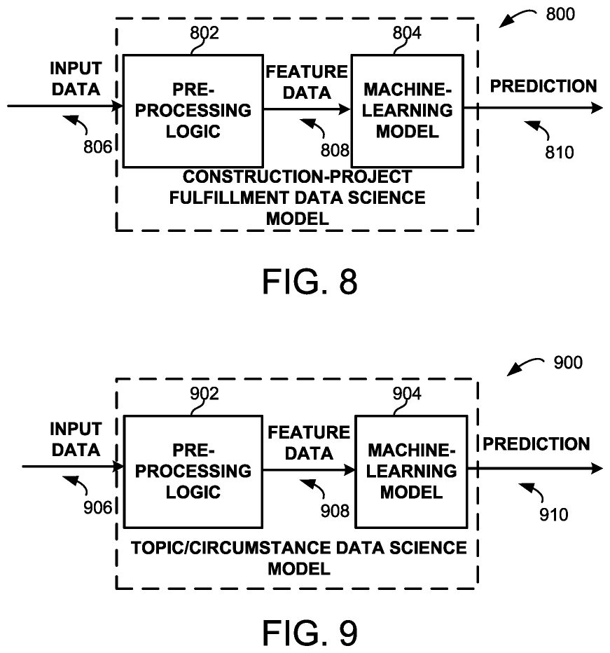

In this respect, FIG. 8 depicts a conceptual illustration of one example of a data science model 800 for determining, on an item-by-item basis, whether a data item corresponds to construction project fulfillment. As shown in FIG. 8, the data science model 800 may comprise pre-processing logic 802 and a machine-learning model 804. The pre-processing logic 802 may function to (i) receive input data 806 for a given data item that represents a first portion of the given data item and (ii) transform the input data 806 for the given data item into feature data 808 for the given data item, which is then provided as input to the machine-learning model 804. In turn, the machine-learning model 804 may comprise any trained model object that is configured to (i) receive the feature data 808 for the given data item as input, (ii) evaluate the feature data 808 for the given data item, and (iii) based on the evaluation of the feature data, determine and output a prediction 810 that takes the form of a prediction of whether the given data item corresponds to construction project fulfillment.

The one or more data science models for predicting whether the given data item corresponds to construction project fulfillment may be created and function in a manner similar to that as described above with respect to the data science model 400, and thus is not described in as great of detail. It should be understood, however, that many of the possibilities and permutations described with respect to the creation and function of the data science model 400 are also possible with respect to the one or more data science models for predicting whether the given data item corresponds to construction project fulfillment. For instance, in an example, the pre-processing logic 802 may take the form of NLP techniques that analyze first portions of the data item and translate the input data 806 into the feature data 808 having an appropriate form for input into the machine-learning model 804. Further, in an example, the data science model 800 may include post-processing logic that may function to evaluate the prediction 810 and then make a determination of whether the given data item corresponds to construction project fulfillment.

As mentioned, the input data 806 may comprise a first portion of a given data item. Example first portions of data items may include things such as (i) a title of a text-based data item, (ii) an abstract of summary of a text-based data item, (iii) an audio-based introduction portion of an audio-based data item, and (iv) a text-based title of an audio-based data item, among various other examples. The data science model may then perform NLP operations (as well as various other operations such as those described with respect to FIG. 4) on the first portion of the given data item to output a predicted likelihood that the given data item corresponds to construction project fulfillment. In practice, this may involve finding information of the given data item that is associated with construction project fulfillment.

To illustrate operations of the data science model 800 with an example, the pre-processing logic 802 may receive a title of a news article entitled “Steel Prices Likely to Surge This Fall Due to Shortage,” and transform the title into feature data 808 comprising key words “Steel,” “Prices Surge,” “This Fall,” and “Shortage.” The machine-learning model 804 may receive the feature data and output a prediction 810 that the news article corresponds to construction project fulfillment. As may be appreciated, various other examples may also exist.

### 3. Determination of Supply-Related Issues

At block 706, the back-end computing platform 102 may evaluate the data items of the construction-project-fulfillment-relevant subset and thereby determine one or more supply-related issues. In some examples, the back-end computing platform 102 may determine a plurality of supply-related issues. In practice, the back-end computing platform may analyze a large number of data items in the construction-project-fulfillment-relevant subset (e.g., on the order of hundreds, thousands, tens of thousands, etc.), and there may be numerous supply-related issues that may be determined based on that analysis. However, in other examples, the back-end computing platform 102 may determine a single supply-related issue.

The back-end computing platform 102 may evaluate the data items of the construction-project-fulfillment-relevant subset and thereby determine one or more supply-related issues in various ways. In practice, the back-end computing platform 102 may begin by identifying respective second portions of the data items of the construction-project-fulfillment-relevant subset, which may take various forms. As one possibility, the second portion of a given data item may comprise any remaining portion of the given data item besides the first portion (e.g., the title or headline of the data item). As another possibility, the second portion of the given data item may be the first portion (e.g., the title or headline) of the given data item, as well as possibly other portions of the given data item. As yet another possibility, the second portion of the given data item may comprise a subportion of the given data item that does not include the first portion (e.g., the title or headline of the data item). Various other possibilities may also exist.

Then, the back-end computing platform 102 may utilize one or more data analytics operations that serve to analyze respective second portions of data items of the construction-project-fulfillment-relevant subset across the different types of data items in order to identify (i) one or more topics referenced in the second portions of data items and/or (ii) one or more circumstances described in the second portions of the data items. As used herein, circumstances may refer to events or conditions that correspond to one or more supply-related issues, such as the supply-related issues previously described, which may have a likelihood of affecting construction project fulfillment. Example circumstances include (i) trade restrictions with various sources of the construction-related item (e.g., international trading bans, etc.), (ii) increased demand for certain construction-related items, (iii) unplanned halts of production from manufacturers of certain construction-related items, and (iv) severe weather conditions (e.g., a tsunami expected to land near a major manufacturer of a given construction-related item), among various other examples.

Such data analytics operations may be performed on an item-by-item basis and may take various forms. As one possibility, the data analytics operations carried out by the back-end computing platform 102 to determine the (i) topics and/or (ii) circumstances referenced in data items of the construction-project-fulfillment-relevant subset may be embodied in the form of one or more data science models that are each configured to determine, on an item-by-item basis, whether a data item corresponds to one or more topics and/or circumstances. In an example, such a data science model may take the form of one or more machine learning models created using a supervised machine learning technique, one example of which is a multi-class classification model.

In this respect, FIG. 9 depicts a conceptual illustration of one example of a data science model 900 for determining, on an item-by-item basis, whether a data item corresponds to one or more topics and/or circumstances. As shown in FIG. 9, the data science model 900 may comprise pre-processing logic 902 and a machine-learning model 904. The pre-processing logic 902 may function to (i) receive input data 906 for a given data item that represents a second portion of the given data item and (ii) transform the input data 906 for the given data item into feature data 908 for the given data item, which is then provided as input to the machine-learning model 904. In turn, the machine-learning model 904 may comprise any trained model object that is configured to (i) receive the feature data 908 for the given data item as input, (ii) evaluate the feature data 908 for the given data item, and (iii) based on the evaluation of the feature data, determine and output a prediction 910 that takes the form of a prediction of which topics and/or circumstances, if any, to which the given data item corresponds.

The one or more data science models for predicting which topics and/or circumstances, if any, the given data item corresponds to may be created and function in a manner similar to that as described above with respect to the data science model 400, and thus is not described in as great of detail. It should be understood, however, that many of the possibilities and permutations described with respect to the creation and function of the data science model 400 are also possible with respect to the one or more data science models for predicting which topics and/or circumstances, if any, to which the given data item corresponds. For instance, in an example, the pre-processing logic 902 may take the form of NLP techniques that analyze second portions of the data item and translate the input data 906 into the feature data 908 having an appropriate form for input into the machine-learning model 904. Further, in an example, the data science model 900 may include post-processing logic that may function to evaluate the prediction 910 and then make a determination of the topics and/or circumstances to which the given data item corresponds.

To illustrate operations of the data science model 900 with an example, the pre-processing logic 902 may receive a news article that describes tsunamis likely to hit Japan in the next few months, and that also describes Japan as a major source of steel. The pre-processing logic 902 may transform the information into feature data 908 comprising key words “Japan,” “Steel,” “Tsunamis,” and “Next few months.” The machine-learning model 904 may receive the feature data and output a prediction that the news article corresponds to (i) a topic referencing steel and (ii) a circumstance referencing tsunamis. As may be appreciated, various other examples may also exist.

The back-end computing platform 102 may then, based on the topics and/or circumstances identified from second portions of the data items of the construction-project-fulfillment-relevant subset, determine one or more supply-related issues. The manners in which the back-end computing platform 102 may determine the one or more supply-related issues based on the topics and/or circumstances may be similar to the manners described above with respect to block 308, and thus are not described in as great of detail. It should be understood, however, that many of the possibilities and permutations described with respect to determining the one or more supply-related issues described with respect to block 308 are also possible with respect to determining the one or more supply-related issues based on the topics and/or circumstances identified from second portions of the data items of the construction-project-fulfillment-relevant subset.

To illustrate determining a supply-related issue based on topics identified data items of the construction-project-fulfillment-relevant subset with an example, the back-end computing platform 102 may determine a supply-chain issue for steel based on identifying an increase in the amount of news articles that reference an upcoming steel shortage. As may be appreciated, various other criteria may be used in addition to or instead of identifying an increase in the amount of news articles that reference a given supply-related issue. Regarding circumstances, for example, the back-end computing platform 102 may have access to information that correlates geographical locations with production sites and/or major trade routes for certain construction-related items. Accordingly, the back-end computing platform 102 may determine a supply-related issue for a given construction-related item based on identifying one or more circumstances that affect geographical locations corresponding to production sites and/or major trade routes for the given construction-related item. Various other examples may also exist.

Additionally, the back-end computing platform 102 may be configured to determine one or more underlying reasons for one or more supply-related issues based on identified topics and/or circumstances. For instance, the back-end computing platform 102 may determine a supply-related issue comprising a supply-chain issue for a given construction-related item, and may additionally determine an underlying reason for the supply-chain issue comprising a severe weather condition that is likely to impact a major manufacturer of the construction-related item. Various other examples may also exist.

### 4. Identification of Construction Project Likely to be Impacted by Supply-Related Issues

At block 708, the back-end computing platform 102 may identify a given construction project that has a likelihood of being impacted by one or more supply-related issues determined by the back-end computing platform 102 at block 706. The back-end computing platform 102 may identify a given construction project that has a likelihood of being impacted by the one or more supply-related issues determined by the back-end computing platform 102 in various ways. In this respect, block 708 is similar in many respects to block 310, and thus is not described in as great of detail. It should be understood, however, that many of the possibilities and permutations described with respect to block 310 are also possible with respect to block 708.

### 5. Determination of Insights for Construction Project Using Identified Supply-Related Issues

At block 710, the back-end computing platform 102 may determine one or more insights for the given construction project based on the one or more supply-related issues determined by the back-end computing platform 102 that are likely to impact the given construction project. The back-end computing platform 102 may determine one or more insights for the given construction project based on the one or more supply-related issues determined by the back-end computing platform 102 that are likely to impact the given construction project in various ways. In this respect, block 710 is similar in many respects to block 312, and thus is not described in as great of detail. It should be understood, however, that many of the possibilities and permutations described with respect to block 312 are also possible with respect to block 710.

Further, the back-end computing platform 102 may be configured to make additional determinations based on the data items of the construction-project-fulfillment-relevant subset. As one example, the back-end computing platform 102 may be configured to determine a reputation of a source of construction-relevant data. In practice this may be accomplished based on a comparison between (i) supply-related issues indicated by construction-relevant data from the source of construction-relevant data and (ii) the one or more supply-related issues determined by the back-end computing platform 102 based on the second portions of the data items of the construction-project-fulfillment-relevant subset. In at least some implementations, the supply-related issues indicated by construction-relevant data from the source of construction-relevant data may also be compared to one or more supply-related issues determined by the back-end computing platform 102 at block 308 of FIG. 3. For example, if the supply-related issues indicated by construction-relevant data from the source of construction-relevant data tend to align with the supply-related issues determined by the back-end computing platform 102 at block 710 and/or block 308, then the back-end computing platform 102 may determine that the source of construction-relevant data has a reputation for providing accurate predictions as to future supply-related issues. On the other hand, if the supply-related issues indicated by construction-relevant data from the source of construction-relevant data do not tend to align with the supply-related issues determined by the back-end computing platform 102 at block 710 and/or block 308, then the back-end computing platform 102 may determine that the source of construction-relevant data has a reputation for providing inaccurate predictions as to future supply-related issues. Various other examples may also exist.

In some examples, the back-end computing platform 102 may be configured to determine a reliability metric to the source of construction-relevant data based on the determined reputation and assign the reliability metric to the source. For instance, in an example, back-end computing platform 102 may rate the reputation of a source based on a scale that quantities reputation from providing accurate predictions as to future supply-related issues to providing inaccurate predictions as to future supply-related issues (e.g., scale from 1 to 10). Such a reliability metric may be utilized when presenting insights to a user.

### 6. Presentation of Indication of One or More Insights

At block 712, the back-end computing platform 102 may transmit, to a client station, data defining the one or more insights for the given construction project and thereby cause an indication of the one or more insights to be presented at a user interface of the client station. The back-end computing platform 102 may transmit, to a client station, data defining the one or more insights for the given construction project and thereby cause an indication of the one or more insights to be presented at a user interface of the client station in various ways. In this respect, block 712 is similar in many respects to block 314, and thus is not described in as great of detail. It should be understood, however, that many of the possibilities and permutations described with respect to block 314 are also possible with respect to block 712.

In some implementations, the client station may be one of the client stations 112 of FIG. 1. In general, the client station may be a client station used by a user associated with the given construction project.

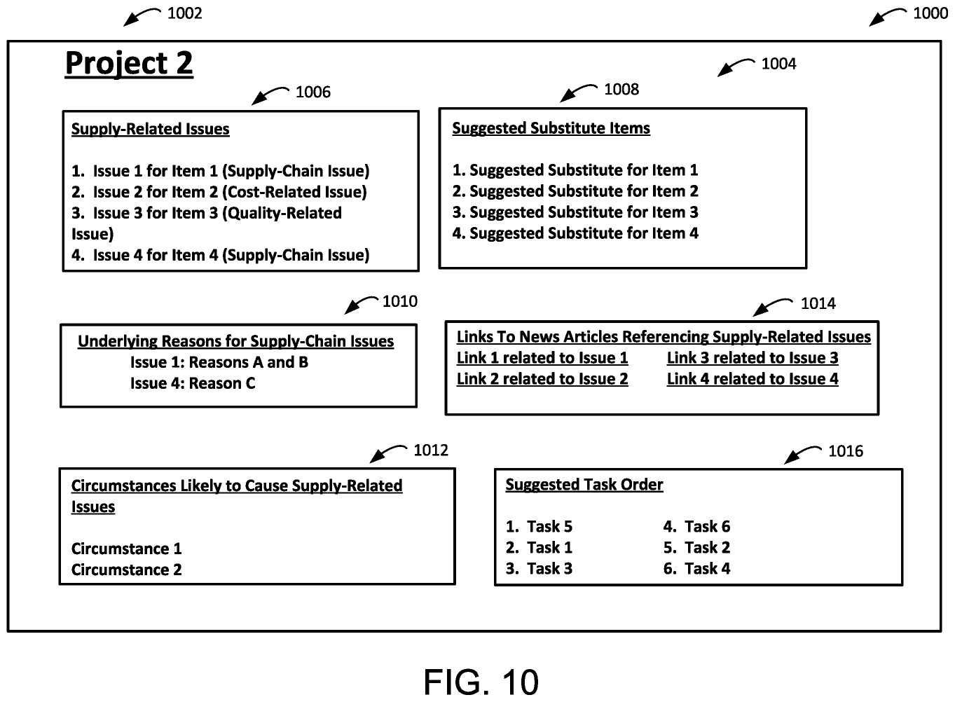

FIG. 10 depicts an example snapshot 1000 of a GUI 1002 that displays information regarding the one or more insights. GUI 1002 includes an indication 1004 of the one or more insights. In this example, the indication 1004 comprises a plurality of indicators for different insights, including an indicator 1006 for insights providing notification of supply-related issues for the construction project, an indicator 1008 for insights related to suggested substitute construction-related items, an indicator 1010 for insights related to underlying reasons for supply-chain issues, an indicator 1012 for insights related to circumstances likely to cause supply-related issues, an indicator 1014 for insights related to links to news articles that reference the supply-related issues, and an indicator 1016 for an insight related to suggested task order. Other examples are possible as well.

Further, the topics and circumstances described above may be from respective universes of available topics and circumstances, which may be defined in various manners, similar to the manners described with respect to the topics of FIG. 3.

### G. Combined Approach Utilizing Data Objects Related to Construction Projects and Construction-Relevant Data

In some examples, identifying supply-related issues and/or determining one or more insights for a given construction project based on one or more supply-related issue may involve both an analysis of a substitution-request-specific subset of data objects and of data items of a construction-project-fulfillment-relevant subset. In general, the approach discussed above with respect to FIG. 3 and the approach discussed above with respect to FIG. 7 may be utilized in combination with one another to identify supply-related issues and/or to determine one or more insights for a given construction project based on one or more supply-related issue. In some implementations, some or all of the operations of FIGS. 3 and 7 may be performed together.

Various examples of a combined approach are possible. For instance, as one possibility, supply-related issues determined based on data items of a construction-project-fulfillment-relevant subset may be verified by supply-related issues determined based on analysis of a substitution-request-specific subset of data objects. In other words, the back-end computing platform 102 may treat a given supply-related issue determined based on data items of a construction-project-fulfillment-relevant subset as verified if a corresponding supply-related issue is determined based on analysis of a substitution-request-specific subset of data objects. In such an example, the back-end computing platform 102 may be configured to (i) identify a given construction project that has a likelihood of being impacted by one or more supply-related issues and (ii) determine one or more insights for a given construction project based on the one or more supply-related issues only for one or more supply-related issues that have been verified. For instance, with reference to FIG. 7, in such an example, the flowchart 700 may involve, prior to performing the operations of blocks 708 and/or 710, the back-end computing platform 102 verifying the determined supply-related issues. Further, block 708 may involve identifying a given construction project that has a likelihood of being impacted by one or more verified supply-related issues. Similarly, block 710 may involve determining one or more insights for the given construction-project based on the one or more of the verified supply-related issues.

As another possibility, supply-related issues determined based on analysis of a substitution-request-specific subset of data objects may be verified by supply-related issues determined based on data items of a construction-project-fulfillment-relevant subset. In such an example, the back-end computing platform 102 may be configured to (i) identify a given construction project that has a likelihood of being impacted by one or more supply-related issues and (ii) determine one or more insights for a given construction project based on the one or more supply-related issues only for one or more supply-related issues that have been verified. For instance, with reference to FIG. 3, in such an example, the flowchart 300 may involve, prior to performing the operations of blocks 310 and/or 312, the back-end computing platform 102 verifying the determined supply-related issues. Further, block 310 may involve identifying a given construction project that has a likelihood of being impacted by one or more verified supply-related issues. Similarly, block 312 may involve determining one or more insights for the given construction-project based on the one or more of the verified supply-related issues.

As yet another possibility, the back-end computing platform 102 may supplement a determination of additional details that may be determined by the back-end computing platform 102 utilizing data objects with information based on external construction-relevant data. For instance, the back-end computing platform 102 may determine an additional detail that describes an underlying reason for a given supply-related issue, such as a supply-chain issue for a given type of chip that is included in a given type of refrigerator that is referenced by a supply-related issue comprising a supply-chain issue for the given type of refrigerator. To supplement the determination of the underlying issue, the back-end computing platform 102 may perform operations of the FIG. 7 to identify one or more circumstances from data items of a construction-project-fulfillment-relevant subset that may describe the supply-related issue comprising the supply-chain issue for the given type of chip.

As still yet another possibility, the back-end computing platform 102 may (i) determine one or more supply-related issues based on topic information from a substitution-request-specific subset of data objects, as described with respect to FIG. 3, and then (ii) determine additional details for the one or more supply-related issues based on topics and/or circumstances identified from data items of a construction-project-fulfillment-relevant subset, as previously described with respect to FIG. 7. For example, the back-end computing platform 102 may determine an expected duration of a given supply-related issue based on circumstances that describe a weather event that may cause the given supply-related issue.

As still yet another possibility, the back-end computing platform 102 may determine one or more supply-related issues based on topic information from a substitution-request-specific subset of data objects, as described with respect to FIG. 3, as well as one or more underlying reasons for the determined supply-related issues, for example, based on topics and/or circumstances identified from data items of a construction-project-fulfillment-relevant subset, as previously described with respect to FIG. 7. Various other examples of a combined approach are possible as well.

### H. Clauses

The disclosure includes example embodiments in accordance with the following clauses:

Clause 1. A computing platform comprising: a network interface; at least one processor; at least one non-transitory computer-readable medium; and program instructions stored on the at least one non-transitory computer-readable medium that are executable by the at least one processor such that the computing platform is configured to: (i) obtain a set of data objects related to construction projects; (ii) evaluate the obtained set of data objects and thereby identify a substitution-request-specific subset of the obtained set of data objects, wherein each data object of the substitution-request-specific subset corresponds to a respective substitution request of a plurality of substitution requests; (iii) for each data object of the substitution-request-specific subset, evaluate the data object and thereby identify one or more topics associated with the data object; (iv) based at least on the identified one or more topics associated with the data objects of the substitution-request-specific subset, determine a plurality of supply-related issues; (v) identify a given construction project that has a likelihood of being impacted by one or more of the plurality of supply-related issues; (vi) determine one or more insights for the given construction project based on the one or more of the plurality of supply-related issues; and (vii) transmit, to a client station, data defining the one or more insights for the given construction project and thereby cause an indication of the one or more insights to be presented at a user interface of the client station.

Clause 2. The computing platform of clause 1, wherein the program instructions that are executable by the at least one processor such that the computing platform is configured to identify the construction project comprise program instructions that are executable by the at least one processor such that the computing platform is configured to identify the construction project based on determining that a construction-related item for the construction project matches a construction-related item related to one or more of the plurality of supply-related issues.

Clause 3. The computing platform of clause 1 or clause 2, wherein the program instructions that are executable by the at least one processor such that the computing platform is configured to determine the plurality of supply-related issues comprise program instructions that are executable by the at least one processor such that the computing platform is configured to determine a supply-chain issue for a construction-related item referenced by substitution requests of the plurality of substitution requests.

Clause 4. The computing platform of clause 3, wherein the supply-chain issue is a wide-spread supply-chain issue for a plurality of providers of the construction-related item referenced by the substitution requests of the plurality of substitution requests for a plurality of providers of the construction-related item.

Clause 5. The computing platform of clause 3, wherein the supply-chain issue is a provider-based supply-chain issue for a subset of providers of a plurality of providers of the construction-related item referenced by the substitution requests of the plurality of substitution requests.

Clause 6. The computing platform of any one of clauses 3-5, wherein the program instructions that are executable by the at least one processor such that the computing platform is configured to identify the construction project comprise program instructions that are executable by the at least one processor such that the computing platform is configured to: (i) determine a period of time during which the supply-chain issue is in effect; and (ii) identify the construction project based on the supply-chain issue having a likelihood of impacting the construction project during the period of time.

Clause 7. The computing platform of any one of clauses 1-6, wherein the program instructions that are executable by the at least one processor such that the computing platform is configured to determine the plurality of supply-related issues comprise program instructions that are executable by the at least one processor such that the computing platform is configured to determine a price issue for a construction-related item referenced by substitution requests of the plurality of substitution requests.

Clause 8. The computing platform of clause 7, wherein the program instructions that are executable by the at least one processor such that the computing platform is configured to determine the price issue for the construction-related item referenced by the substitution requests of the plurality of substitution requests comprise program instructions that are executable by the at least one processor such that the computing platform is configured to determine that the substitution requests of the plurality of substitution requests indicate respective requests to substitute the construction-related item with a more cost-efficient construction-related item.

Clause 9. The computing platform of clause 8, wherein the program instructions that are executable by the at least one processor such that the computing platform is configured to determine the one or more insights for the construction project based on the one or more of the plurality of supply-related issues comprise program instructions that are executable by the at least one processor such that the computing platform is configured to: (i) determine that a construction-related item for the construction project matches the construction-related item referenced by the substitution requests of the plurality of substitution requests; and (ii) determine that the construction-related item for the construction project may be substituted with the more cost-efficient construction-related item.

Clause 10. The computing platform of any one of clauses 1-9, wherein the program instructions that are executable by the at least one processor such that the computing platform is configured to determine the plurality of supply-related issues comprise program instructions that are executable by the at least one processor such that the computing platform is configured to: identify an uptick of substitution requests for a given construction-related item associated with a given trade as compared to an extent of substitution requests for construction-related items associated with the given trade.

Clause 11. The computing platform of any one of clauses 1-10, wherein the program instructions that are executable by the at least one processor such that the computing platform is configured to evaluate the obtained set of data objects and thereby identify the substitution-request specific subset comprise program instructions that are executable by the at least one processor such that the computing platform is configured to use a first machine learning model to evaluate the obtained set of data object and thereby identify the substitution-request specific subset; and wherein the program instructions that are executable by the at least one processor such that the computing platform is configured to, for each data object of the substitution-request-specific subset, evaluate the data object and thereby identify the one or more topics associated with the data object comprise program instructions that are executable by the at least one processor such that the computing platform is configured to use a second machine learning model to evaluate the data object and thereby identify the one or more topics associated with the data object.

Clause 12. The computing platform of any one of clauses 1-11, further comprising program instructions stored on the at least one non-transitory computer-readable medium that are executable by the at least one processor such that the computing platform is configured to: based at least on the one or more topics associated with the data objects of the substitution-request-specific subset, determine an underlying reason for a supply-related issue of the plurality of supply-related issue.

Clause 13. The computing platform of clause 12, further comprising program instructions that are executable by the at least one processor such that the computing platform is configured to: (i) obtain a set of news feed data; and (ii) evaluate the set of news feed data to determine a temporary circumstance that affects an availability of one or more construction-related items; and wherein the program instructions that are executable by the at least one processor such that the computing platform is configured to determine the underlying reason for the supply-related issue of the plurality of supply-related issues comprise program instructions that are executable by the at least one processor such that the computing platform is configured to determine the underlying reason based on determining that the temporary circumstance affects the availability of the one or more construction-related items.

Clause 14. A non-transitory computer-readable medium, wherein the non-transitory computer-readable medium is provisioned with program instructions that, when executed by at least one processor, cause a computing platform to: (i) obtain a set of data objects related to construction projects; (ii) evaluate the obtained set of data objects and thereby identify a substitution-request-specific subset of the obtained set of data objects, wherein each data object of the substitution-request-specific subset corresponds to a respective substitution request of a plurality of substitution requests; (iii) for each data object of the substitution-request-specific subset, evaluate the data object and thereby identify one or more topics associated with the data object; (iv) based at least on the identified one or more topics associated with the data objects of the substitution-request-specific subset, determine a plurality of supply-related issues; (v) identify a given construction project that has a likelihood of being impacted by one or more of the plurality of supply-related issues; (vi) determine one or more insights for the given construction project based on the one or more of the plurality of supply-related issues; and (vii) transmit, to a client station, data defining the one or more insights for the given construction project and thereby cause an indication of the one or more insights to be presented at a user interface of the client station.

Clause 15. The non-transitory computer-readable medium of clause 14, wherein the program instructions that are executable by the at least one processor such that the computing platform is configured to determine the plurality of supply-related issues comprise program instructions that are executable by the at least one processor such that the computing platform is configured to determine a price issue for a construction-related item referenced by substitution requests of the plurality of substitution requests.

Clause 16. The non-transitory computer-readable medium of clause 14, wherein the program instructions that, when executed by at least one processor, cause the computing platform to identify the construction project comprise program instructions that, when executed by at least one processor, cause the computing platform to determine a supply-chain issue for a construction-related item referenced by substitution requests of the plurality of substitution requests.

Clause 17. The non-transitory computer-readable medium of clause 14 or clause 15, wherein the program instructions that, when executed by at least one processor, cause the computing platform to determine the plurality of supply-related issues comprise program instructions that, when executed by at least one processor, cause the computing platform to identify the construction project based on determining that a construction-related item for the construction project matches a construction-related item related to one or more of the plurality of supply-related issues.

Clause 18. The non-transitory computer-readable medium of clause 17, wherein the supply-chain issue is a wide-spread supply-chain issue for a plurality of providers of the construction-related item referenced by the substitution requests of the plurality of substitution requests for a plurality of providers of the construction-related item.

Clause 19. The non-transitory computer-readable medium of clause 17, wherein the supply-chain issue is a provider-based supply-chain issue for a subset of providers of a plurality of providers of the construction-related item referenced by the substitution requests of the plurality of substitution requests.

Clause 20. A method implemented by a computing platform, the method comprising: (i) obtaining a set of data objects related to construction projects; (ii) evaluating the obtained set of data objects and thereby identifying a substitution-request-specific subset of the obtained set of data objects, wherein each data object of the substitution-request-specific subset corresponds to a respective substitution request of a plurality of substitution requests; (iii) for each data object of the substitution-request-specific subset, evaluating the data object and thereby identify one or more topics associated with the data object; (iv) based at least on the identified one or more topics associated with the data objects of the substitution-request-specific subset, determining a plurality of supply-related issues; (v) identifying a given construction project that has a likelihood of being impacted by one or more of the plurality of supply-related issues; (vi) determining one or more insights for the given construction project based on the one or more of the plurality of supply-related issues; and (vii) transmitting, to a client station, data defining the one or more insights for the given construction project and thereby causing an indication of the one or more insights to be presented at a user interface of the client station.

Clause 21. A computing platform comprising: a network interface; at least one processor; at least one non-transitory computer-readable medium; and program instructions stored on the at least one non-transitory computer-readable medium that are executable by the at least one processor such that the computing platform is configured to: (i) obtain a set of construction-relevant data; (ii) evaluate the obtained set of construction-relevant data and thereby identify a construction-project-fulfillment-relevant subset of data items of the obtained set of construction-relevant data, wherein each data item of the construction-project-fulfillment-relevant subset corresponds to construction project fulfillment; (iii) evaluate the data items of the construction-project-fulfillment-relevant subset and thereby determine a plurality of supply-related issues; (iv) identify a given construction project that has a likelihood of being impacted by one or more of the plurality of supply-related issues; (v) determine one or more insights for the given construction project based on the one or more of the plurality of supply-related issues; and (vi) transmit, to a client station, data defining the one or more insights for the given construction project and thereby cause an indication of the one or more insights to be presented at a user interface of the client station.

Clause 22. The computing platform of clause 21, wherein the program instructions that are executable by the at least one processor such that the computing platform is configured to obtain the set of construction-relevant data comprise program instructions that are executable by the at least one processor such that the computing platform is configured to obtain the set of construction-relevant data from an external source of construction-relevant data.

Clause 23. The computing platform of clause 21 or clause 22, wherein the program instructions that are executable by the at least one processor such that the computing platform is configured to evaluate the obtained set of construction-relevant data and thereby identify the construction-project-fulfillment-relevant subset comprise program instructions that are executable by the at least one processor such that the computing platform is configured to evaluate respective first portions of construction-relevant data items of the obtained set of construction-relevant data to identify the construction-project-fulfillment-relevant subset.

Clause 24. The computing platform of clause 23, wherein the respective first portions of the construction-relevant data items comprise one or more of (i) respective text-based descriptors of respective text-based construction-relevant data items, (ii) respective text-based descriptors of respective audio-based construction-relevant data items, or (iii) respective audio-based portions of respective audio-based construction-relevant data items.

Clause 25. The computing platform of clause 23 or clause 24, wherein the program instructions that are executable by the at least one processor such that the computing platform is configured to evaluate the data items of the construction-project-fulfillment-relevant subset and thereby determine the plurality of supply-related issues comprise program instructions that are executable by the at least one processor such that the computing platform is configured to: (i) for each data item of the construction-project-fulfillment-relevant subset, evaluate a respective second portion of the data item to determine, from the respective second portion, one or more circumstances that have a likelihood of affecting construction project fulfillment; and (ii) based on the circumstances that have likelihoods of affecting construction project fulfillment, determine the plurality of supply-related issues.

Clause 26. The computing platform of any one of clauses 21-25, wherein the program instructions that are executable by the at least one processor such that the computing platform is configured to evaluate the obtained set of construction-relevant data and thereby identify the construction-project-fulfillment-relevant subset comprise program instructions that are executable by the at least one processor such that the computing platform is configured to use a first machine learning model to evaluate the obtained set of construction-relevant data and thereby identify the construction-project-fulfillment-relevant subset; and wherein the program instructions that are executable by the at least one processor such that the computing platform is configured to evaluate the data items of the construction-project-fulfillment-relevant subset and thereby determine the plurality of supply-related issues comprise program instructions that are executable by the at least one processor such that the computing platform is configured to use a second machine learning model to evaluate the data items of the construction-project-fulfillment-relevant subset and thereby determine the plurality of supply-related issues.

Clause 27. The computing platform of any one of clauses 21-26, further comprising program instructions that are executable by the at least one processor such that the computing platform is configured to: (i) obtain a set of data objects related to construction projects; and (ii) evaluate the construction project data objects to thereby determine supply-related issue information; and wherein the program instructions that are executable by the at least one processor such that the computing platform is configured to determine the plurality of supply-related issues comprise program instructions that are executable by the at least one processor such that the computing platform is configured to determine the plurality of supply-related issues at least partially based on the determined supply-related issue information.

Clause 28. The computing platform of any one of clauses 21-27, further comprising program instructions that are executable by the at least one processor such that the computing platform is configured to obtain a set of data objects related to construction projects; and wherein the program instructions that are executable by the at least one processor such that the computing platform is configured to identify the given construction project that has the likelihood of being impacted by one or more of the plurality of supply-related issues comprise program instructions that are executable by the at least one processor such that the computing platform is configured to evaluate (i) the set of data objects related to construction projects and (ii) the plurality of supply-related issues to identify the given construction project.

Clause 29. The computing platform of any one of clauses 21-28, further comprising program instructions stored on the at least one non-transitory computer-readable medium that are executable by the at least one processor such that the computing platform is configured to determine a reliability of a source of construction-relevant data based on a comparison between (i) supply-related issues indicated by construction-relevant data from the source of construction-relevant data and (ii) the one or more determined supply-related issues.

Clause 30. The computing platform of any one of clauses 21-29, wherein the set of construction-relevant data comprises at least one of (i) news feed data, (ii) construction-related reports generated by government agencies, (iii) construction-related reports generated by construction-related organizations, (iv) social media content, or (iv) weather reports.

Clause 31. A non-transitory computer-readable medium, wherein the non-transitory computer-readable medium is provisioned with program instructions that, when executed by at least one processor, cause a computing platform to: (i) obtain a set of construction-relevant data; (ii) evaluate the obtained set of construction-relevant data and thereby identify a construction-project-fulfillment-relevant subset of data items of the obtained set of construction-relevant data, wherein each data item of the construction-project-fulfillment-relevant subset corresponds to construction project fulfillment; (iii) evaluate the data items of the construction-project-fulfillment-relevant subset and thereby determine a plurality of supply-related issues; (iv) identify a given construction project that has a likelihood of being impacted by one or more of the plurality of supply-related issues; (v) determine one or more insights for the given construction project based on the one or more of the plurality of supply-related issues; and (vi) transmit, to a client station, data defining the one or more insights for the given construction project and thereby cause an indication of the one or more insights to be presented at a user interface of the client station.

Clause 32. The non-transitory computer-readable medium of clause 31, wherein the program instructions that, when executed by at least one processor, cause the computing platform to obtain the set of construction-relevant data comprise program instructions that, when executed by at least one processor, cause the computing platform to obtain the set of construction-relevant data from an external source of construction-relevant data.

Clause 33. The non-transitory computer-readable medium of clause 31 or clause 32, wherein the program instructions that, when executed by at least one processor, cause the computing platform to evaluate the obtained set of construction-relevant data and thereby identify the construction-project-fulfillment-relevant subset comprise program instructions that, when executed by at least one processor, cause the computing platform to evaluate respective first portions of construction-relevant data items of the obtained set of construction-relevant data to identify the construction-project-fulfillment-relevant subset.

Clause 34. The non-transitory computer-readable medium of clause 33, wherein the respective first portions of the construction-relevant data items comprise one or more of (i) respective text-based descriptors of respective text-based construction-relevant data items, (ii) respective text-based descriptors of respective audio-based construction-relevant data items, or (iii) respective audio-based portions of respective audio-based construction-relevant data items.

Clause 35. The non-transitory computer-readable medium of any one of clauses 31-34, wherein the program instructions that, when executed by at least one processor, cause the computing platform to evaluate the data items of the construction-project-fulfillment-relevant subset and thereby determine the plurality of supply-related issues comprise program instructions that, when executed by at least one processor, cause the computing platform to: (i) for each data item of the construction-project-fulfillment-relevant subset, evaluate a respective second portion of the data item to determine, from the respective second portion, one or more circumstances that have a likelihood of affecting construction project fulfillment; and (ii) based on the circumstances that have likelihoods of affecting construction project fulfillment, determine the plurality of supply-related issues.

Clause 36. The non-transitory computer-readable medium of any one of clauses 31-35, wherein the program instructions that, when executed by at least one processor, cause the computing platform to evaluate the obtained set of construction-relevant data and thereby identify the construction-project-fulfillment-relevant subset comprise program instructions that, when executed by at least one processor, cause the computing platform to use a first machine learning model to evaluate the obtained set of construction-relevant data and thereby identify the construction-project-fulfillment-relevant subset; and wherein the program instructions that, when executed by at least one processor, cause the computing platform to evaluate the data items of the construction-project-fulfillment-relevant subset and thereby determine the plurality of supply-related issues comprise program instructions that, when executed by at least one processor, cause the computing platform to use a second machine learning model to evaluate the data items of the construction-project-fulfillment-relevant subset and thereby determine the plurality of supply-related issues.

Clause 37. The non-transitory computer-readable medium of any one of clauses 31-36, wherein the non-transitory, computer-readable medium is also provisioned with program instructions that, when executed by at least one processor, cause the computing platform to: (i) obtain a set of data objects related to construction projects; and (ii) evaluate the construction project data objects to thereby determine supply-related issue information; and wherein the program instructions that, when executed by at least one processor, cause the computing platform to determine the plurality of supply-related issues comprise program instructions that, when executed by at least one processor, cause the computing platform to determine the plurality of supply-related issues at least partially based on the determined supply-related issue information.

Clause 38. The non-transitory computer-readable medium of any one of clauses 31-37, wherein the non-transitory, computer-readable medium is also provisioned with program instructions that, when executed by at least one processor, cause the computing platform to: (i) obtain a set of data objects related to construction projects; and (ii) wherein the program instructions that, when executed by at least one processor, cause the computing platform to identify the given construction project that has the likelihood of being impacted by one or more of the plurality of supply-related issues comprise program instructions that, when executed by at least one processor, cause the computing platform to evaluate (i) the set of data objects related to construction projects and (ii) the plurality of supply-related issues to identify the given construction project.

Clause 39. The non-transitory computer-readable medium of any one of clauses 31-28, wherein the non-transitory, computer-readable medium is also provisioned with program instructions that, when executed by at least one processor, cause the computing platform to determine a reliability of a source of construction-relevant data based on a comparison between (i) supply-related issues indicated by construction-relevant data from the source of construction-relevant data and (ii) the one or more determined supply-related issues.

Clause 40. A method implemented by a computing platform, the method comprising: (i) obtaining a set of construction-relevant data; (ii) evaluating the obtained set of construction-relevant data and thereby identify a construction-project-fulfillment-relevant subset of data items of the obtained set of construction-relevant data, wherein each data item of the construction-project-fulfillment-relevant subset corresponds to construction project fulfillment; (iii) evaluating the data items of the construction-project-fulfillment-relevant subset and thereby determine a plurality of supply-related issues; (iv) identifying a given construction project that has a likelihood of being impacted by one or more of the plurality of supply-related issues; (v) determining one or more insights for the given construction project based on the one or more supply-related issues; and (vi) transmitting, to a client station, data defining the one or more insights for the given construction project and thereby cause an indication of the one or more insights to be presented at a user interface of the client station.

### IV. Conclusion

Example embodiments of the disclosed innovations have been described above. Those skilled in the art will understand, however, that changes and modifications may be made to the embodiments described without departing from the true scope and spirit of the present invention, which will be defined by the claims.

For instance, those in the art will understand that the disclosed operations for determining one or more insights based on determined supply-related issues may not be limited to only construction projects. Rather, the disclosed operations could be used in other contexts in connection with other types of projects as well.

Further, to the extent that examples described herein involve operations performed or initiated by actors, such as “humans,” “operators,” “users,” or other entities, this is for purposes of example and explanation only. The claims should not be construed as requiring action by such actors unless explicitly recited in the claim language.

1. A computing platform comprising:
a network interface;
at least one processor;
at least one non-transitory computer-readable medium; and
program instructions stored on the at least one non-transitory computer-readable medium that are executable by the at least one processor such that the computing platform is configured to:
obtain a set of data objects related to construction projects;
evaluate the obtained set of data objects and thereby identify a substitution-request-specific subset of the obtained set of data objects, wherein each data object of the substitution-request-specific subset corresponds to a respective substitution request of a plurality of substitution requests;
for each data object of the substitution-request-specific subset, evaluate the data object and thereby identify one or more topics associated with the data object;
based at least on the identified one or more topics associated with the data objects of the substitution-request-specific subset, determine a plurality of supply-related issues;
identify a given construction project that has a likelihood of being impacted by one or more of the plurality of supply-related issues;
determine one or more insights for the given construction project based on the one or more of the plurality of supply-related issues; and
transmit, to a client station, data defining the one or more insights for the given construction project and thereby cause an indication of the one or more insights to be presented at a user interface of the client station.

2. The computing platform of claim 1, wherein the program instructions that are executable by the at least one processor such that the computing platform is configured to identify the construction project comprise program instructions that are executable by the at least one processor such that the computing platform is configured to identify the construction project based on determining that a construction-related item for the construction project matches a construction-related item related to one or more of the plurality of supply-related issues.

3. The computing platform of claim 1, wherein the program instructions that are executable by the at least one processor such that the computing platform is configured to determine the plurality of supply-related issues comprise program instructions that are executable by the at least one processor such that the computing platform is configured to determine a supply-chain issue for a construction-related item referenced by substitution requests of the plurality of substitution requests.

4. The computing platform of claim 3, wherein the supply-chain issue is a wide-spread supply-chain issue for a plurality of providers of the construction-related item referenced by the substitution requests of the plurality of substitution requests for a plurality of providers of the construction-related item.

5. The computing platform of claim 3, wherein the supply-chain issue is a provider-based supply-chain issue for a subset of providers of a plurality of providers of the construction-related item referenced by the substitution requests of the plurality of substitution requests.

6. The computing platform of claim 3, wherein the program instructions that are executable by the at least one processor such that the computing platform is configured to identify the construction project comprise program instructions that are executable by the at least one processor such that the computing platform is configured to:
determine a period of time during which the supply-chain issue is in effect; and
identify the construction project based on the supply-chain issue having a likelihood of impacting the construction project during the period of time.

7. The computing platform of claim 1, wherein the program instructions that are executable by the at least one processor such that the computing platform is configured to determine the plurality of supply-related issues comprise program instructions that are executable by the at least one processor such that the computing platform is configured to determine a price issue for a construction-related item referenced by substitution requests of the plurality of substitution requests.

8. The computing platform of claim 7, wherein the program instructions that are executable by the at least one processor such that the computing platform is configured to determine the price issue for the construction-related item referenced by the substitution requests of the plurality of substitution requests comprise program instructions that are executable by the at least one processor such that the computing platform is configured to determine that the substitution requests of the plurality of substitution requests indicate respective requests to substitute the construction-related item with a more cost-efficient construction-related item.

9. The computing platform of claim 8, wherein the program instructions that are executable by the at least one processor such that the computing platform is configured to determine the one or more insights for the construction project based on the one or more of the plurality of supply-related issues comprise program instructions that are executable by the at least one processor such that the computing platform is configured to:
determine that a construction-related item for the construction project matches the construction-related item referenced by the substitution requests of the plurality of substitution requests; and
determine that the construction-related item for the construction project may be substituted with the more cost-efficient construction-related item.

10. The computing platform of claim 1, wherein the program instructions that are executable by the at least one processor such that the computing platform is configured to determine the plurality of supply-related issues comprise program instructions that are executable by the at least one processor such that the computing platform is configured to:
identify an uptick of substitution requests for a given construction-related item associated with a given trade as compared to an extent of substitution requests for construction-related items associated with the given trade.

11. The computing platform of claim 1, wherein the program instructions that are executable by the at least one processor such that the computing platform is configured to evaluate the obtained set of data objects and thereby identify the substitution-request specific subset comprise program instructions that are executable by the at least one processor such that the computing platform is configured to use a first machine learning model to evaluate the obtained set of data object and thereby identify the substitution-request specific subset; and
wherein the program instructions that are executable by the at least one processor such that the computing platform is configured to, for each data object of the substitution-request-specific subset, evaluate the data object and thereby identify the one or more topics associated with the data object comprise program instructions that are executable by the at least one processor such that the computing platform is configured to use a second machine learning model to evaluate the data object and thereby identify the one or more topics associated with the data object.

12. The computing platform of claim 1, further comprising program instructions stored on the at least one non-transitory computer-readable medium that are executable by the at least one processor such that the computing platform is configured to:
based at least on the one or more topics associated with the data objects of the substitution-request-specific subset, determine an underlying reason for a supply-related issue of the plurality of supply-related issue.

13. The computing platform of claim 12, further comprising program instructions that are executable by the at least one processor such that the computing platform is configured to:
obtain a set of news feed data; and
evaluate the set of news feed data to determine a temporary circumstance that affects an availability of one or more construction-related items; and
wherein the program instructions that are executable by the at least one processor such that the computing platform is configured to determine the underlying reason for the supply-related issue of the plurality of supply-related issues comprise program instructions that are executable by the at least one processor such that the computing platform is configured to determine the underlying reason based on determining that the temporary circumstance affects the availability of the one or more construction-related items.

14. A non-transitory computer-readable medium, wherein the non-transitory computer-readable medium is provisioned with program instructions that, when executed by at least one processor, cause a computing platform to:
obtain a set of data objects related to construction projects;
evaluate the obtained set of data objects and thereby identify a substitution-request-specific subset of the obtained set of data objects, wherein each data object of the substitution-request-specific subset corresponds to a respective substitution request of a plurality of substitution requests;
for each data object of the substitution-request-specific subset, evaluate the data object and thereby identify one or more topics associated with the data object;
based at least on the identified one or more topics associated with the data objects of the substitution-request-specific subset, determine a plurality of supply-related issues;
identify a given construction project that has a likelihood of being impacted by one or more of the plurality of supply-related issues;
determine one or more insights for the given construction project based on the one or more of the plurality of supply-related issues; and
transmit, to a client station, data defining the one or more insights for the given construction project and thereby cause an indication of the one or more insights to be presented at a user interface of the client station.

15. The non-transitory computer-readable medium of claim 14, wherein the program instructions that are executable by the at least one processor such that the computing platform is configured to determine the plurality of supply-related issues comprise program instructions that are executable by the at least one processor such that the computing platform is configured to determine a price issue for a construction-related item referenced by substitution requests of the plurality of substitution requests.

16. The non-transitory computer-readable medium of claim 14, wherein the program instructions that, when executed by at least one processor, cause the computing platform to identify the construction project comprise program instructions that, when executed by at least one processor, cause the computing platform to determine a supply-chain issue for a construction-related item referenced by substitution requests of the plurality of substitution requests.

17. The non-transitory computer-readable medium of claim 14, wherein the program instructions that, when executed by at least one processor, cause the computing platform to determine the plurality of supply-related issues comprise program instructions that, when executed by at least one processor, cause the computing platform to identify the construction project based on determining that a construction-related item for the construction project matches a construction-related item related to one or more of the plurality of supply-related issues.

18. The non-transitory computer-readable medium of claim 17, wherein the supply-chain issue is a wide-spread supply-chain issue for a plurality of providers of the construction-related item referenced by the substitution requests of the plurality of substitution requests for a plurality of providers of the construction-related item.

19. The non-transitory computer-readable medium of claim 17, wherein the supply-chain issue is a provider-based supply-chain issue for a subset of providers of a plurality of providers of the construction-related item referenced by the substitution requests of the plurality of substitution requests.

20. A method implemented by a computing platform, the method comprising:
obtaining a set of data objects related to construction projects;
evaluating the obtained set of data objects and thereby identifying a substitution-request-specific subset of the obtained set of data objects, wherein each data object of the substitution-request-specific subset corresponds to a respective substitution request of a plurality of substitution requests;
for each data object of the substitution-request-specific subset, evaluating the data object and thereby identifying one or more topics associated with the data object;
based at least on the identified one or more topics associated with the data objects of the substitution-request-specific subset, determining a plurality of supply-related issues;
identifying a given construction project that has a likelihood of being impacted by one or more of the plurality of supply-related issues;
determining one or more insights for the given construction project based on the one or more of the plurality of supply-related issues; and
transmitting, to a client station, data defining the one or more insights for the given construction project and thereby causing an indication of the one or more insights to be presented at a user interface of the client station.
